(19) United States
(12) Patent Application Publication
(10) Pub. No.: US 2016/0021362 A1
(43) Pub. Date: Jan. 21, 2016

(54) DISPLAY DEVICE AND DISPLAY METHOD

(71) Applicant: JAPAN DISPLAY INC., Tokyo (JP)

(72) Inventors: Yingbao Yang, Tokyo (JP); Takeo Koito, Tokyo (JP)

(21) Appl. No.: 14/799,078

(22) Filed: Jul. 14, 2015

(30) Foreign Application Priority Data
Jul. 15, 2014 (JP) 2014-145267

(51) Int. Cl. H04N 13/04

(52) U.S. Cl. CPC H04N 13/0409

(57) ABSTRACT

A display device includes: a display unit that displays, in a screen, images corresponding to viewpoints existing in a X direction; and a parallax forming unit that divides light existing between the display unit and the respective viewpoints with respect to the X direction so that different lights reach the respective viewpoints from the display unit due to light blocking or refraction, and guides the images corresponding to the respective viewpoints to the respective viewpoints. In a case where the width of each of the pixels in the X direction and/or the width of each of the pixels in a Y direction is equal to or smeller than a predetermined width, the parallax forming unit divides light beams existing between the display unit and the respective viewpoints so that light of more than one pixel is included in each minimum divisional unit region formed through the dividing.

### CROSS-REFERENCE TO RELATED APPLICATIONS

This application claims priority from Japanese Application No. 2014-145267, filed on Jul. 15, 2014, the contents of which are incorporated by reference herein in its entirety.

### BACKGROUND

1. Technical Field

The present disclosure relates to a display device and a display method.

2. Description of the Related Art

A method of generating parallax between the right eye and the left eye has been known as a method of causing a user to visually recognize an image displayed on a two-dimensional screen as a three-dimensional image. As a method of generating parallax, there is a known method of displaying images corresponding to respective viewpoints in one screen, and providing a parallax barrier in front of the screen (see JP 2008-513807 W). This method realizes stereoscopic viewing by dividing light beams existing between the image in the screen and the respective viewpoints for each of the viewpoints, using the parallax barrier.

When an image in a screen is divided with a parallax barrier in a conventional case, the parallax barrier divides light beams with a light transmissive unit provided to match the width of each of the pixels constituting the image. Therefore, as the display device achieves a higher definition, the width of light to be allowed to pass through the parallax barrier becomes

However, if the width of light to be allowed to pass through the parallax barrier becomes too small, an image overlap phenomenon (crosstalk) due to light diffraction occurs. Light diffraction is a phenomenon in which light travels to make a detour to avoid an obstacle existing in the light path. Therefore, light diffraction occurs due to the parallax barrier serving as an obstacle. Since light diffraction is a natural phenomenon, the range of light diffusion caused by diffraction with the same obstacle is constant. Therefore, as the width of light allowed to pass through the parallax barrier becomes smaller, the ratio of the range of light diffusion caused by diffraction to the width of light becomes higher. When the width of light allowed to pass through the parallax barrier becomes smaller with increase in definition, an image overlap phenomenon caused by light diffusing at viewpoints becomes too apparent to be ignored.

For the foregoing reason, there is a need for proving a display device and display method which suppresse an image overlap phenomenon. Or, there is a need for proving a display device and display method which achieve a higher definition, and also suppress an image overlap phenomenon.

### SUMMARY

According to an aspect, A display device includes a display unit configured to display, in a screen, images corresponding to a plurality of viewpoints existing in a predetermined direction, and a parallax forming unit configured to divide light existing between the display unit and the respective viewpoints with respect to the predetermined direction so that different lights reach the respective viewpoints from the display unit due to light blocking or refraction, and guide the images corresponding to the respective viewpoints to the respective viewpoints. The display unit includes a plurality of pixels displaying the images, and, when at least one of a width of each of the pixels in the predetermined direction, and a width of each of the pixels in a direction parallel to the screen as well as perpendicular to the predetermined direction is equal to or smaller than a predetermined width, the parallax forming unit divides light beams existing between the display unit and the respective viewpoints so that light of a plurality of pixels is included in a minimum divisional unit region formed through the dividing.

According to an another aspect, a display method implemented by a display device includes a display unit configured to display, in a screen, images corresponding to a plurality of viewpoints existing in a predetermined direction; and a parallax forming unit configured to divide light existing between the display unit and the respective viewpoints with respect to the predetermined direction so that different lights reach the respective viewpoints from the display unit due to light blocking or refraction, and guide the images corresponding to the respective viewpoints to the respective viewpoints. The display method includes dividing light beams existing between the display unit and the respective viewpoints so that light of a plurality of pixels is included in a minimum divisional unit region formed through the dividing, when at least one of a width of each of a plurality of pixels displaying the images in the predetermined direction and a width of each of the pixels in a direction parallel to the screen and perpendicular to the predetermined direction is equal to or smaller than a predetermined width.

### BRIEF DESCRIPTION OF THE DRAWINGS

FIG. 1 is a block diagram illustrating an example functional structure of a display device according to this embodiment;

FIG. 2 is a perspective view of an example layout of the illuminating unit, the display unit, and the barrier unit of the display device illustrated in FIG. 1;

FIG. 3 is a perspective diagram illustrating the relationship between the pixels of the display unit and the unit regions of the barrier unit;

FIG. 4 is a cross-sectional diagram schematically illustrating a cross-section structure of a module that includes the display unit and the barrier unit;

FIG. 5 is a circuit diagram illustrating the pixel array of the display unit;

FIG. 6 is a schematic view of a pixel in color display;

FIG. 7 is a schematic view of a pixel in monochrome display;

FIG. 8 is a diagram illustrating the concept of a control method according to this embodiment;

FIG. 9 is a diagram illustrating an example of display of right-eye images and left-eye images on the display unit;

FIG. 10 is a diagram illustrating part of the visible range to be visually recognized with the left eye of a user;

FIG. 11 is a diagram illustrating part of the visible range to be visually recognized with the right eye of the user;

FIG. 12 is a diagram illustrating a modification example in display of right-eye images and left-eye images;

FIG. 13 is a flowchart of the control according to this embodiment;

FIG. 14 is a diagram illustrating an example structure of the barrier unit;

FIG. 15 is a diagram illustrating an example of a light blocking pattern and a light transmitting pattern of the barrier unit in a case where the color pixels illustrated in FIG. 6 are successively arranged in the X-direction;

FIG. 16 is a diagram illustrating an example of diffracted light intensity in diffraction that occurs at an opening;

FIG. 17 is a graph illustrating an example of the relationship between the width of an opening in the X-direction and the diffracted light half-value angle;

FIG. 18 is a diagram illustrating an example of the correspondence relationship between the number of pixels from which light is guided by one opening, and the angle distribution of diffracted light due to diffraction that occurs in this light;

FIG. 19 is a diagram illustrating an example of an arrangement pattern of images for the right eye and images for the left eye in a case where the number of pixels included in each minimum divisional unit region is two;

FIG. 20 is a graph illustrating an example of the correspondence relationship between the distance from the display device to the viewpoints and occurrence of an image overlap phenomenon;

FIG. 21 is a graph illustrating an example of the correspondence relationship between the distance from the display device to the viewpoints and the width of the smallest opening that can prevent image overlap phenomena;

FIG. 22 is a diagram illustrating an example of an arrangement pattern of images for the right eye and images for the left eye in a case where each unit pixel is formed with pixels R, G, B, and W;

FIG. 23 is a diagram illustrating another example of an arrangement pattern of images for the right eye and images for the left eye in a case where each unit pixel is formed with pixels R, G, and B;

FIG. 24 is a diagram illustrating another example of an arrangement pattern of images for the right eye and images for the left eye in a case where each unit pixel is formed with pixels R, G, B, and W;

FIG. 25 is a diagram illustrating an example of an arrangement pattern of images for the right eye and images for the left eye in a case where each unit pixel is formed with 2×2 pixels;

FIG. 26 is a diagram illustrating an example method of manufacturing the barrier unit;

FIG. 27 is a diagram illustrating the example method of manufacturing the barrier unit;

FIG. 28 is a diagram illustrating the example method of manufacturing the barrier unit;

FIG. 29 is a diagram illustrating the example method of manufacturing the barrier unit;

FIG. 30 is a diagram illustrating the example method of manufacturing the barrier unit;

FIG. 31 is a diagram illustrating the example method of manufacturing the barrier unit;

FIG. 32 is a flowchart of an example method of manufacturing the display device according to the embodiment;

FIG. 33 is a diagram illustrating an example of an electronic apparatus in which the display device according to this embodiment is used;

FIG. 34 is a diagram illustrating an example of an electronic apparatus in which the display device according to this embodiment is used; and

FIG. 35 is a diagram illustrating an example structure of a barrier unit that divides image light and guides the divided light to respective viewpoints through lenses.

### DETAILED DESCRIPTION

The following is a description of respective embodiments of the present invention, with reference to the accompanying drawings.

The present disclosure is merely an example, and modifications that could have easily been made by those skilled in the art maintaining the spirit of the invention are of course included in the scope of the present invention. To make the description of the invention clearer, the widths, the thicknesses, the shapes, and the like of respective components are illustrated in the drawings in a more schematic manner than in actual forms, but they are merely examples and do not restrict interpretation of the present invention. In this specification and the respective drawings, like components are denoted by like reference numerals, and explanations of them may not be repeated more than once.

A display device 1 according to this embodiment can be used as a display device that displays a three-dimensional image by controlling a barrier unit 6 stacked on a display unit 4, for example. The display unit 4 of the display device 1 may be a liquid crystal display (LCD) panel, an organic electro-luminescence (OEL) display, or a micro electro mechanical system (MEMS), for example.

The display device 1 according to this embodiment can be used as both a display device for monochrome display and a display device for color display. In the case of a display device for color display, one pixel serving as a unit forming a color image (unit pixel) includes sub pixels. More specifically, in a display device for color display, one pixel includes three sub pixels: a sub pixel displaying red (R), a sub pixel displaying green (G), and a sub pixel displaying blue (B).

One pixel is not limited to a combination of sub pixels of the three primary colors of RGB, and one pixel may be formed with sub pixels of the three primary colors of RGB and one or more color sub pixels. More specifically, one pixel may be formed by adding a sub pixel displaying white (W) to the three primary color sub pixels so as to increase luminance, or one pixel may be formed by adding at least one sub pixel displaying a complementary color to the three primary color sub pixels so as to widen the color reproduction range.

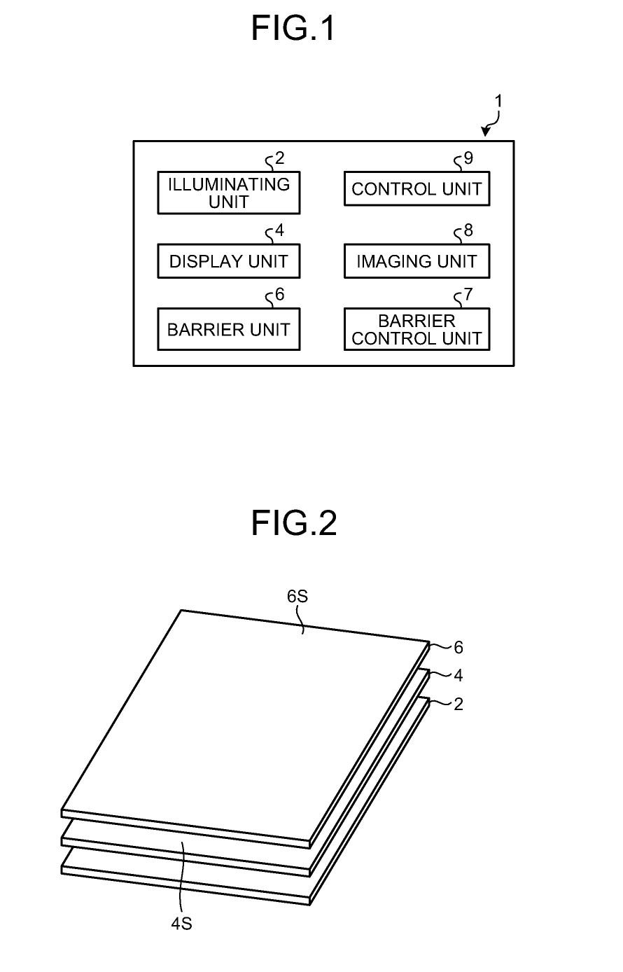

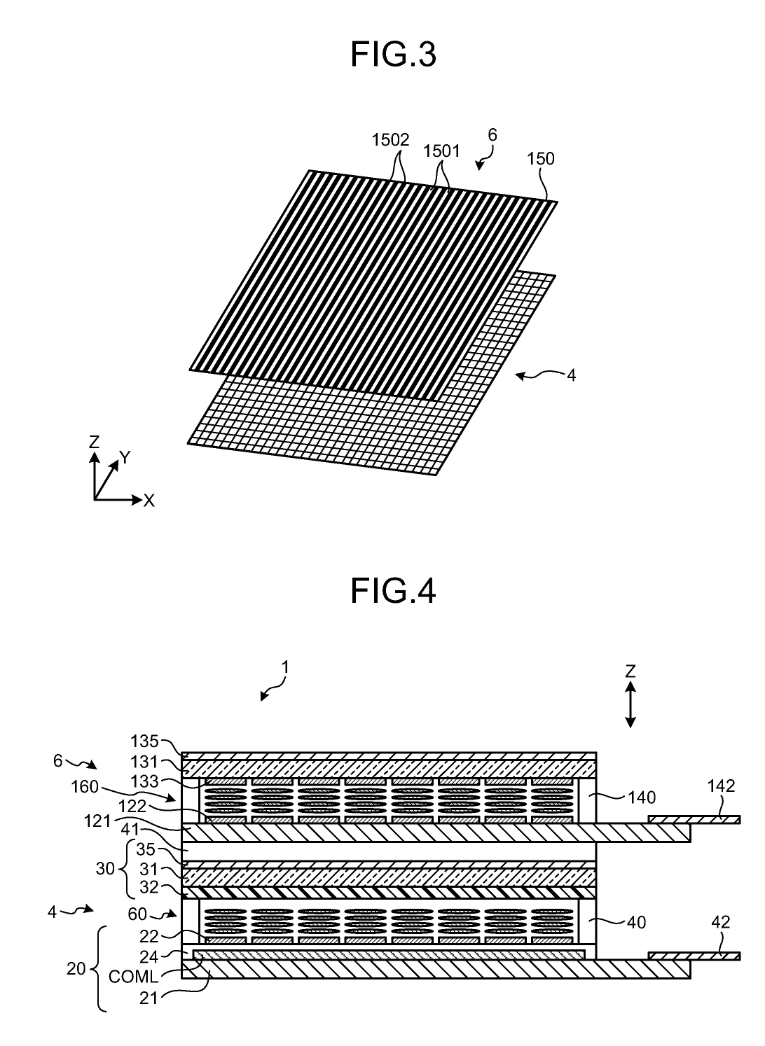

FIG. 1 is a block diagram illustrating an example functional structure of the display device 1 according to this embodiment. FIG. 2 is a perspective view of an example layout of an illuminating unit 2, the display unit 4, and the barrier unit 6 of the display device 1 illustrated in FIG. 1. FIG. 3 is a perspective diagram illustrating the relationship between the pixels of the display unit 4 and unit regions 150 of the barrier unit 6. FIGS. 2 and 3 are schematic diagrams, and the sizes and the shapes illustrated therein are not necessarily match the actual sizes and the actual shapes. The display device 1 illustrated in FIG. 1 is an example of the display device of the present disclosure. The barrier unit 6 illustrated in FIG. 1 is an example of a parallax forming unit of the present disclosure.

The display device 1 displays an image so that a user (a user U1, for example) looking at the screen from a predetermined position can recognize a three-dimensional image with the naked eye. As illustrated in FIG. 1, the display device 1 includes the illuminating unit 2, the display unit 4, the barrier unit 6, a barrier control unit 7, an imaging unit 8, and a control unit 9. In the display device 1, the illuminating unit 2, the display unit 4, and the barrier unit 6 are stacked in this order, for example.

The illuminating unit 2 is an illuminating device that emits planar light toward the display unit 4. The illuminating unit 2 is provided as the backlight for the display unit 4, for example. The illuminating unit 2 includes a light source and a light guide panel, for example, and emits light originating from the light source through the emitting surface facing the display unit 4, while scattering the light with the light guide panel.

The display unit 4 displays an image. The display unit 4 is a liquid crystal panel on which pixels are arranged in a two-dimensional array as illustrated in FIG. 3. The light emitted from the illuminating unit 2 enters the display unit 4. The display unit 4 displays an image on a display surface 4S illustrated in FIG. 2, by switching between transmitting and blocking of the light entering the respective pixels.

The barrier unit 6 is located on the surface of the display unit 4 on which an image of the display unit 4 is displayed (see FIG. 2), or the opposite surface facing the illuminating unit 2. In the description below, the direction in which the unit regions 150 are arranged is the X-direction, the direction that is perpendicular to the X-direction and in which each of the unit regions 150 extends is the Y-direction, and the direction that is perpendicular to both the X-direction and the Y-direction is the Z-direction. As illustrated in FIG. 3, in the barrier unit 6, the unit regions 150 extending in the Y-direction are arranged in a row in the X-direction. The barrier unit 6 is a liquid crystal panel, for example, and voltage is partially applied to the liquid crystals, to orient the liquid crystals. Through such an operation, the barrier unit 6 switches between transmitting and blocking of light which enters each of the unit regions 150, from the surface on the light emitting side (a surface 6S illustrated in FIG. 2, for example). By doing so, the barrier unit 6 adjusts, in the Y-direction, the regions that transmit the image to be displayed on the display unit 4 (transmissive regions 1501), and the regions that block the image to be displayed on the display unit 4 (light blocking regions 1502). In other words, the transmissive regions 1501 are the unit regions 150 controlled to transmit the image to be displayed on the display unit 4. The light blocking regions 1502 are the unit regions 150 controlled to block the image to be displayed on the display unit 4.

The barrier control unit 7 controls operation of the barrier unit 6. Specifically, the barrier control unit 7 controls operation (transmitting/blocking) in each of the unit regions 150 of the barrier unit 6, to adjust the regions that transmit the image to be displayed on the display unit 4, and the regions that block the image to be displayed on the display unit 4.

The imaging unit 8 captures an image. A digital camera is used as the imaging unit 8, for example. In the display device 1 that displays a three-dimensional image by controlling the barrier unit 6, a so-called head-tracking technology or a so-called eye-tracking technology or the like is used. By a head-tracking technology or an eye-tracking technology, an image of a user is captured by the imaging unit 8, and the position of the user in the image, such as the positions of the eyes of the user, is detected or measured. Although the positional information about a user is acquired from an image captured by the imaging unit in this embodiment, the method of acquiring the positional information is not limited to that. For example, the positional information about a user may be acquired with at least one of a temperature sensor such as an infrared sensor, a sound sensor such as a microphone, an optical sensor, and the like. The positional information about a user may be acquired by sensing the position using a RFID (radio frequency identifier), an IC tag, or the like.

The control unit 9 controls operation of each component of the display device 1. Specifically, the control unit 9 controls switching on and off of the illuminating unit 2, and the amount and the intensity of light when the illuminating unit 2 is on, to control the image to be displayed on the display unit 4.

As the control unit 9 controls image display of the display unit 4, and the barrier control unit 7 controls operation (transmitting/blocking) in each of the unit regions 150 of the barrier unit 6, display of a three-dimensional image is realized.

The barrier control unit 7 and the control unit 9 are a computer including a CPU (Central Processing Unit) as an arithmetic device and a memory as a storage device, for example. The barrier control unit 7 and the control unit 9 can also realize various kinds of functions by executing a computer program using those hardware resources. Specifically, the barrier control unit 7 and the control unit 9 read and load a computer program stored in a predetermined storage unit (not illustrated) into a memory, and cause the CPU to execute commands included in the program loaded into the memory. In accordance with the results of the execution of the commands by the CPU, the control unit 9 controls switching on and off of the illuminating unit 2, and the amount and the intensity of light when the illuminating unit 2 is on, to control the image to be displayed on the display unit 4. The barrier control unit 7 controls operation (transmitting/blocking) in each of the unit regions 150 of the barrier unit 6.

The display device 1 of this embodiment has a parallax forming mode as the operation mode for displaying a three-dimensional image, and a regular display mode as the operation mode for displaying a two-dimensional image. The control unit 9 and the barrier control unit 7 control switching between the parallax forming mode and the regular display mode. In the case of the regular display mode, the barrier control unit 7 performs control so that the entire barrier unit 6 becomes a transmissive region, and the control unit 9 performs control so that one image is displayed on the entire screen of the display unit 4.

Next, the processes related to the parallax forming mode, or the processes to be performed by the barrier control unit 7 and the control unit 9 to display a three-dimensional image in this embodiment, are described. The control unit 9 detects the positions of the right eye and the left eye of a user from an image acquired by the imaging unit 8. In accordance with the positions of the right eye and the left eye of the user, and the distance between the display device 1 and the positions of the right eye and the left eye, the control unit 9 determines pixel display that is the contents of display of the pixels of the right-eye images to be displayed on the display unit 4 and the pixels of the left-eye images to be displayed on the display unit 4. In accordance with the positions of the right eye and the left eye of the user, and the pixel display, the barrier control unit 7 determines whether each of the unit regions of the barrier unit 6 is to be a transmissive region 1501 or a light blocking region 1502. That is, the barrier control unit 7 controls transmission of light through the barrier unit 6, so that a right-eye image is visually recognized with the right eye of the user, and a left-eye image is visually recognized with the left eye of the user, via the unit regions 150 of the barrier unit 6. In this manner, the display device 1 displays an image to be three-dimensionally recognized by a user. The display unit and the barrier unit

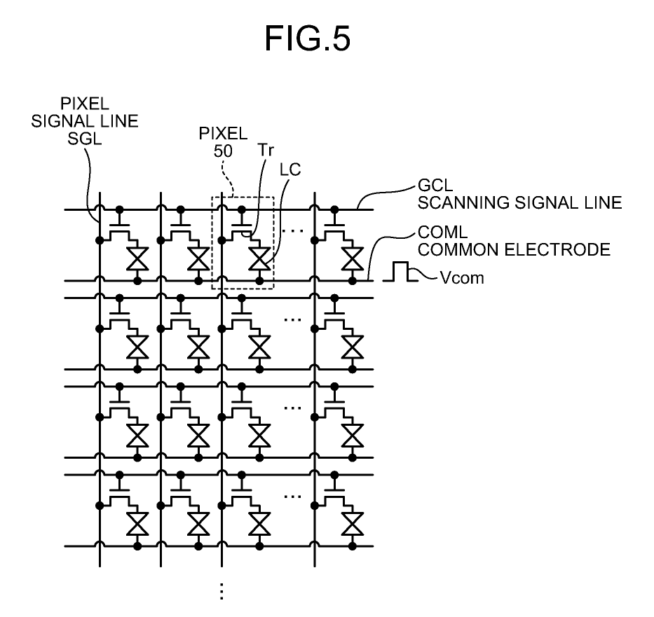

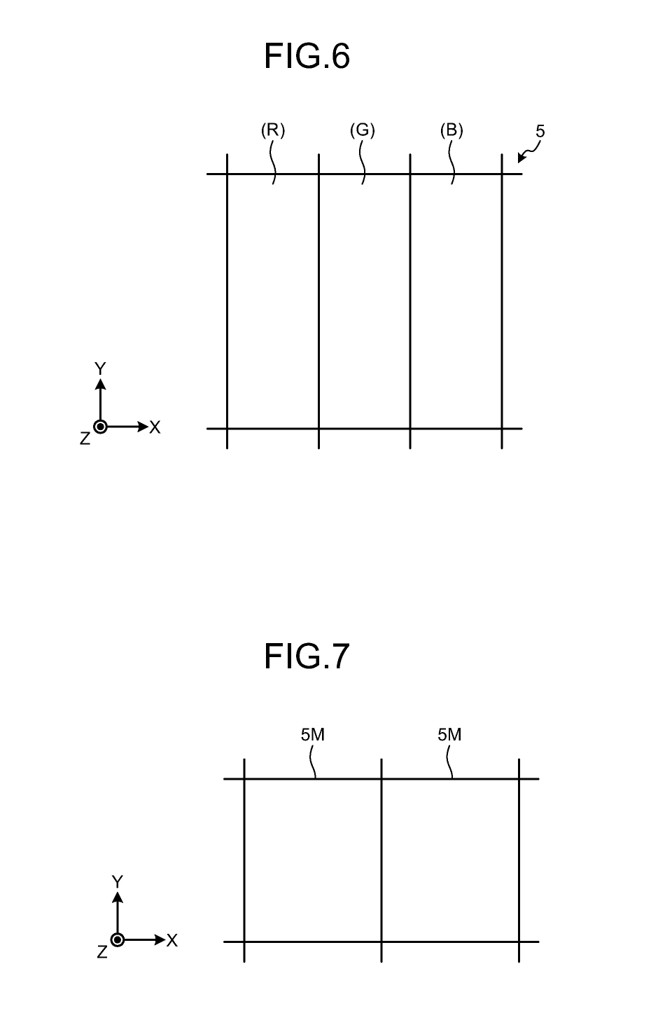

Next, example structures of the display unit 4 and the barrier unit 6 are described. FIG. 4 is a cross-sectional diagram schematically illustrating a cross-section structure of a module that includes the display unit 4 and the barrier unit 6. FIG. 5 is a circuit diagram illustrating the pixel array of the display unit 4. FIG. 6 is a schematic view of a pixel in color display. FIG. 7 is a schematic view of a pixel in monochrome display.

As illustrated in FIG. 4, in the display device 1, the barrier unit 6 is stacked on the display unit 4. In the display device 1 in this embodiment, the display unit 4 and the barrier unit 6 are bonded to each other by an adhesion layer 41. The display unit 4 includes a pixel substrate 20, a counter substrate 30 located to face a surface of the pixel substrate 20 in the vertical direction, and a liquid crystal layer 60 interposed between the pixel substrate 20 and the counter substrate 30.

The pixel substrate 20 includes a TFT substrate 21 as the circuit board, pixel electrodes 22 arranged in a matrix fashion on a surface of the TFT substrate 21, common electrodes COML formed between the TFT substrate 21 and the pixel electrodes 22, and an insulating layer 24 insulating the pixel electrodes 22 from the common electrodes COML. Although the common electrodes COML, the insulating layer 24, and the pixel electrodes 22 are stacked in this order in FIG. 4, the stacking order is not limited to that. The pixel electrodes 22, the insulating layer 24, and the common electrodes COML may be stacked in this order, or the pixel electrodes 22 and the common electrodes COML may be arranged in the same plane, with the insulating layer being interposed in between. In the TFT substrate 21, the thin film transistor (TFT) elements Tr of respective pixels 50 illustrated in FIG. 5, wirings such as pixel signal lines SGL supplying pixel signals to the respective pixel electrodes 22 and scanning signal lines GCL driving the respective TFT elements Tr are formed. The pixel signal lines SGL extend in a plane parallel to the surfaces of the TFT substrate 21, and supply pixel signals for displaying an image on the pixels. The pixel substrate 20 illustrated in FIG. 5 includes the pixels 50 arranged in a matrix fashion. The pixels 50 each include a TFT element Tr and liquid crystal LC. In the example illustrated in FIG. 5, each of the TFT elements Tr is formed with an n-channel MOS (Metal Oxide Semiconductor) TFT element. The source of each of the TFT elements Tr is coupled to a pixel signal line SGL, the gate is coupled to a scanning signal line GCL, and the drain is coupled to one end of the liquid crystal LC. The one end of the liquid crystal LC is coupled to the drain of the TFT element Tr, and the other end is coupled to a common electrode COML.

The pixels 50 belonging to the same line in the pixel substrate 20 are electrically coupled to one another by a scanning signal line GCL (the same applies in the description below). The scanning signal lines GCL are coupled to a gate driver, and scanning signals (Vscan) are supplied from the gate driver. The pixels 50 belonging to the same row in the pixel substrate 20 are coupled to one another by a pixel signal line SGL. The pixel signal lines SGL are coupled to a source driver, and pixel signals (Vpix) are supplied from the source driver. The pixels 50 belonging to the same line in the pixel substrate 20 are further coupled to one another by a common electrode COML. The common electrodes COML are coupled to a common electrode driver, and drive signals (Vcom) are supplied from the common electrode driver. That is, in the example illustrated in FIG. 5, the pixels 50 belonging to the same line share one common electrode COML.

The display unit 4 applies a scanning signal (Vscan) to the gates of the TFT elements Tr of pixels 50 from the gate driver via a scanning signal line GCL illustrated in FIG. 5, to sequentially select one line (one horizontal line) of the pixels 50 formed in a matrix fashion in the pixel substrate 20, as the display drive targets. The display unit 4 supplies a pixel signal (Vpix) to each of the pixels 50 forming a sequentially-selected horizontal line from the source driver via a pixel signal line SGL illustrated in FIG. 5. These pixels 50 are designed to display the one horizontal line in accordance with the supplied pixel signal (Vpix). The display unit 4 applies a drive signal (Vcom), to drive a common electrode COML.

As described above, the display unit 4 operates to perform line sequential scanning on the scanning signal lines GCL in a time-division manner, to sequentially select one horizontal line. The display unit 4 also supplies a pixel signal (Vpix) to the pixels 50 belonging to one horizontal line, so that display is performed for one horizontal line at a time. When performing this display operation, the display unit 4 applies a drive signal (Vcom) to the corresponding common electrode COML.

Referring back to FIG. 4, the counter substrate 30 includes a glass substrate 31 and a color filter 32 formed on one surface of the glass substrate 31. A polarizer 35 is provided on the other surface of the glass substrate 31. The barrier unit 6 is bonded to the surface of the polarizer 35 on the opposite side from the side of the glass substrate 31, by the adhesion layer 41. The color filter 32 may be formed on the side of the pixel substrate 20.

In the color filter 32, color filters colored in the three colors of red (R), green (G), and blue (B), for example, are cyclically arranged, and the three colors R, G, and B are associated as one set with each of the above described pixels 50 illustrated in FIG. 5. Specifically, one pixel serving as a unit forming a color image, or a unit pixel 5, includes sub pixels, as illustrated in FIG. 6, for example. In this example, a unit pixel 5 includes a sub pixel (R) displaying R, a sub pixel (B) displaying B, and a sub pixel (G) displaying G. The sub pixels (R), (B), and (G) in a unit pixel 5 are arranged in the X-direction, which means in the line direction of the display device 1. The color filter 32 faces the liquid crystal layer 60 in a direction perpendicular to the surfaces of the TFT substrate 21. The color filter 32 maybe colored in a different combination of colors, as long as the colors are different from one another.

A unit pixel 5 may further include one or more sub pixels of one or more colors. In a case where the display unit 4 is compatible only with monochrome display, one pixel serving as a unit forming a monochrome image, or one unit pixel 5M, is equivalent to one pixel 50 (a sub pixel in a color image), as illustrated in FIG. 7. A unit pixel 5 is a base unit for displaying a color image, and a unit pixel 5M is a base unit for displaying a monochrome image.

The common electrodes COML function as common drive electrodes (counter electrodes) of the display unit 4. In this embodiment, each of the common electrodes COML is a plate-like electrode to be shared among pixel electrodes 22. The common electrodes COML may be arranged so that one common electrode COML may correspond to more than one pixel electrode 22 (the pixel electrodes 22 constituting one line). The common electrodes COML face the pixel electrodes 22 in the direction perpendicular to the surfaces of the TFT substrate 21, and extend in a direction parallel to the direction in which the above described scanning signal lines GCL extend. A drive signal having an alternating rectangular waveform is applied from a drive electrode driver to each of the common electrodes COML. The TFT substrate 21 and the color filter 32 are bonded to each other by a sealing material 40.

The liquid crystal layer 60 is to modulate light passing therethrough, in accordance with the state of electric field. The liquid crystal forming the liquid crystal layer 60 is liquid crystal compatible with the liquid crystal display panel forming the display unit 4. Specifically, the display unit 4 of this embodiment is a liquid crystal display panel in a horizontal field mode such as IPS (In-Plane Switching), and the liquid crystal used as the liquid crystal layer 60 is liquid crystal suited to the liquid crystal display panel. The display unit 4 is not necessarily a liquid crystal display panel in a horizontal field mode, and may be a liquid crystal display panel in a vertical field mode. The liquid crystal forming the liquid crystal layer 60 may also be changed as appropriate in accordance with the liquid crystal display panel forming the display unit 4. For example, the liquid crystal used as the liquid crystal layer 60 may be liquid crystal in a mode such as TN (Twisted Nematic), VA (Vertical Alignment), or ECB (Electrically Controlled Birefringence).

An oriented film may be provided between the liquid crystal layer 60 and the pixel substrate 20, and another oriented film may be provided between the liquid crystal layer 60 and the counter substrate 30. An incidence-side polarizer may be provided on the lower surface side of the pixel substrate 20.

The barrier unit 6 includes: a substrate 121; unit region electrodes 122 provided in rows on the substrate 121; a glass substrate 131; drive electrodes 133 arranged on the surface of the glass substrate 131 on the side of the unit region electrodes 122; and a polarizer 135 provided on the other surface of the glass substrate 131.

The region between the surface of the glass substrate 131 on the side of the drive electrodes 133 and the surface of the substrate 121 on the side of the unit region electrodes 122 is filled with a liquid crystal layer 160. The liquid crystal layer 160 is to modulate light passing therethrough, in accordance with the state of electric field. In this embodiment, the liquid crystal layer 160 is a liquid crystal display panel in a vertical field mode such as TN, VA, or ECB. However, the liquid crystal layer 160 is not limited to that, and a liquid crystal display panel in a horizontal field mode may be used instead. For example, liquid crystal in a horizontal field mode such as IPS may be used. An oriented film may be provided between the liquid crystal layer 160 and the substrate 121, and another oriented film may be provided between the liquid crystal layer 160 and the glass substrate 131. Further, an incidence-side polarizer may be provided on the lower surface side of the substrate 121 or on the side of the display unit 4.

The unit region electrodes 122 have the same shapes as those of the unit regions 150 illustrated in FIG. 3, and are in long plate-like forms extending in a first direction (the Y-direction). The unit region electrodes 122 are provided in lines along a second direction (the X-direction). The glass substrate 131 and the substrate 121 are bonded to each other by a sealing material 140. That is, the unit region electrodes 122 are provided to correspond to the respective unit regions 150.

The display unit 4 and the barrier unit 6 have the above described structures, and switch voltages to be applied to the pixel electrodes 22 and the unit region electrodes 122 based on signals from the control unit 9, to display an image to be three-dimensionally recognized by the user. Control method

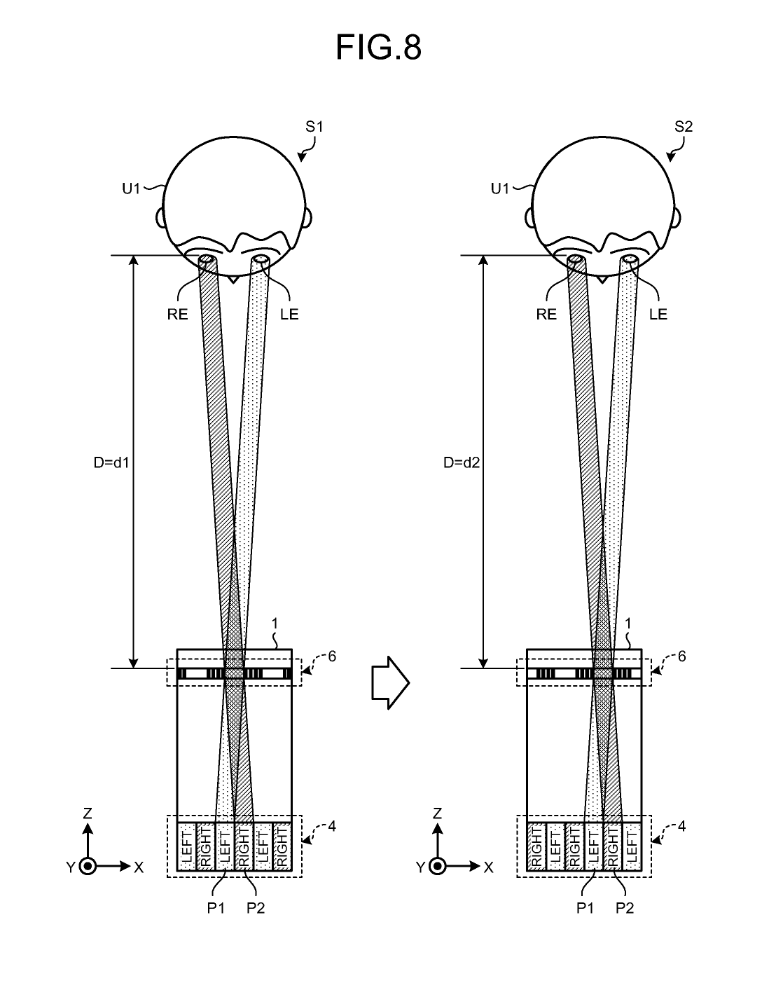

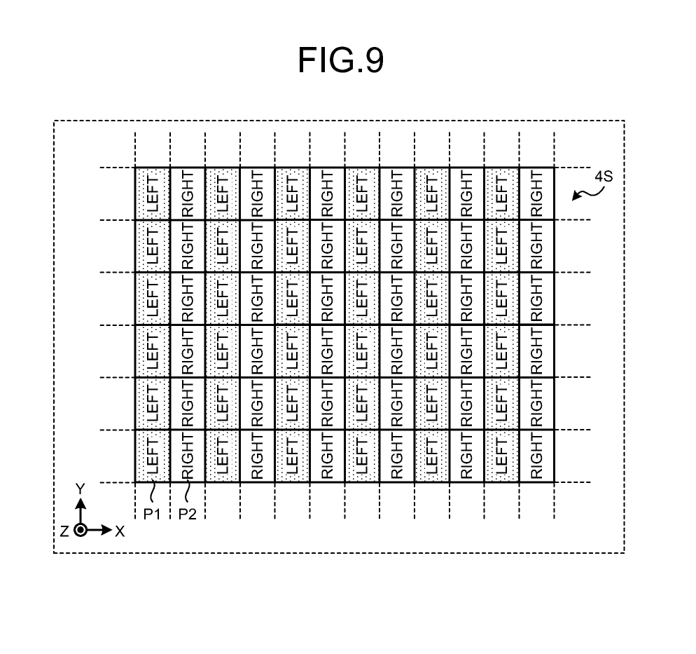

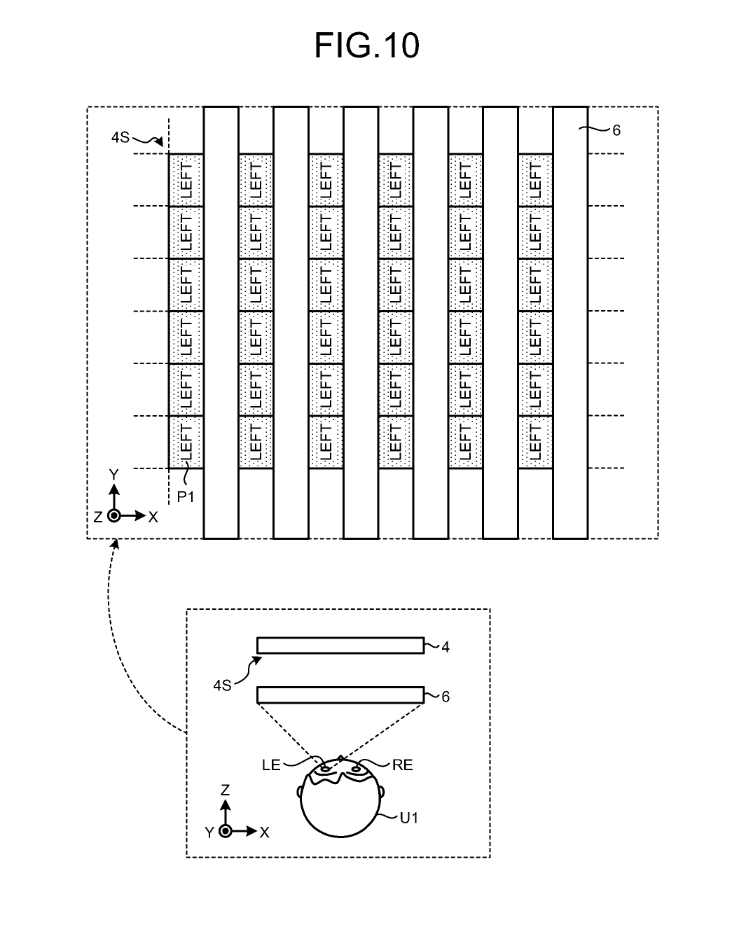

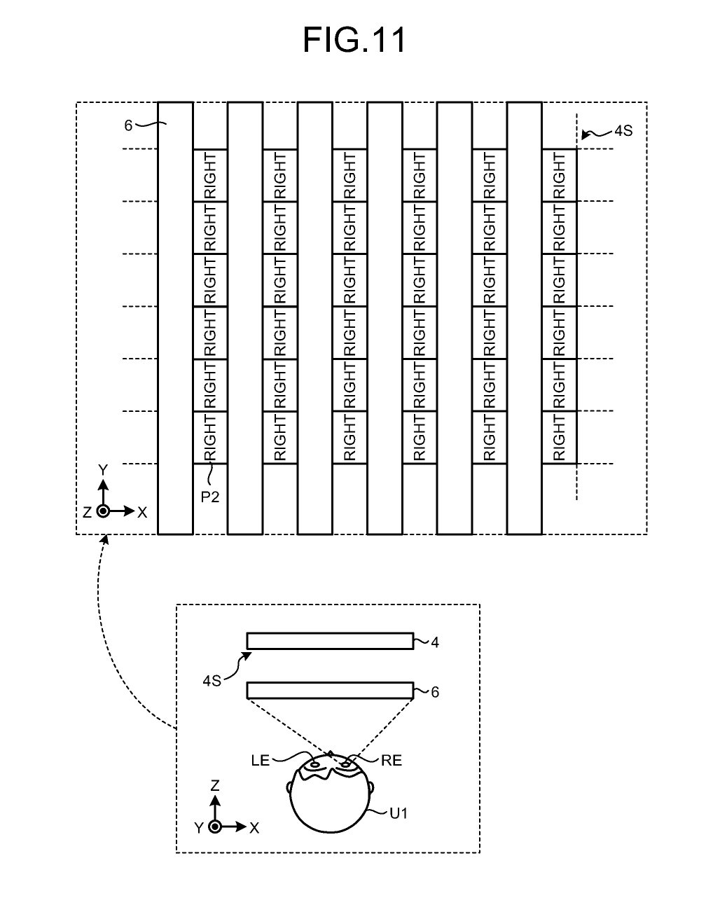

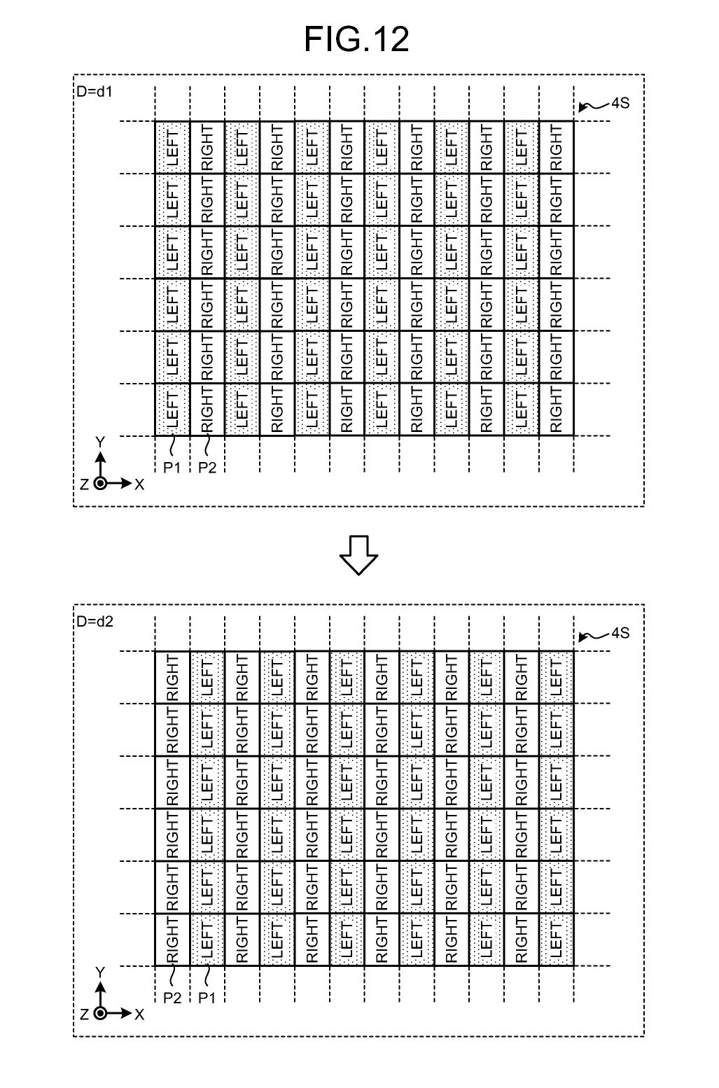

Referring now to FIGS. 8 through 12, the control method implemented by the barrier control unit 7 and the control unit 9 is described in detail. FIG. 8 is a diagram illustrating the concept of the control method according to this embodiment. FIG. 9 is a diagram illustrating an example of display of right-eye images and left-eye images on the display unit 4. FIG. 10 is a diagram illustrating part of the visible range to be visually recognized with the left eye of a user. FIG. 11 is a diagram illustrating part of the visible range to be visually recognized with the right eye of the user. FIG. 12 is a diagram illustrating a modification example in display of right-eye images and left-eye images.

The control unit 9 detects the positions of the right eye and the left eye of a user U1 from an image of the user taken by the imaging unit 8. Specifically, the control unit 9 acquires information about the position of the user (viewer). The information about the position of the user indicates the position of the face (the middle position, for example) of the user. Specifically, the information about the position of the user indicates the position of the face of the user that can be determined from the positions of the right eye and the left eye of the user, for example. The control unit 9 then calculates the distance from the user U1 to the barrier unit 6. Specifically, the control unit 9 calculates the distance from the middle position between the positions of the right eye RE and the left eye LE to the middle position of the barrier unit 6, for example. In this manner, the control unit 9 functions as the calculating unit that determines the position of a viewpoint with respect to the parallax forming unit (the barrier unit 6) from the positional information about the right eye RE and the left eye LE of the user, and calculates the distance between the viewpoint and the parallax forming unit. In the description below, this distance will be referred to as the “distance between the display device 1, and the positions of the right eye RE and the left eye LE of the user U1” in this embodiment. This distance to be calculated by the control unit 9 is merely an example, and may be a distance indicating the positional relationship between the barrier unit 6 and the positions of the right eye RE and the left eye LE of the user U1. For example, the control unit 9 may calculate the line segments connecting the middle position of the barrier unit 6 and the right eye RE and the left eye LE. The control unit 9 may calculate the distance between the position of the user U1, and the point of contact with the barrier unit 6 on an extension line of the visual line which is determined from the positions of the right eye RE and the left eye LE of the user U1.

When the display device 1 is activated, for example, the control unit 9 calculates the distance between the display device 1 and the positions of the right eye RE and the left eye LE of the user U1, as the reference distance which is to be used in controlling the display unit 4 and the barrier unit 6. The reference distance is equivalent to the distance between the display device 1 (the barrier unit 6) and the positions of the right eye RE and the left eye LE of the user U1 viewing an image displayed on the display unit 4, for example. The barrier control unit 7 determines display of the right-eye images and the left-eye images to be displayed on the display unit 4 in accordance with the reference distance calculated by the control unit 9. And the barrier control unit 7 determines the positions of the transmissive regions 1501 and the light blocking regions 1502 in the barrier unit 6 in accordance with the positions of the right eye RE and the left eye LE of the user U1 and the above display. Based on the positions of the right eye RE and the left eye LE of the user U1 detected from an image captured by the imaging unit 8 under the control of the control unit 9, and the distance between the display unit 4 and the barrier unit 6, the barrier control unit 7 determines the unit regions 150 to be the transmissive regions 1501 and the unit regions 150 to be the light blocking regions 1502 among the respective unit regions 150 of the barrier unit 6, so that light is guided from each corresponding image to each of the right eye RE and the left eye LE.

As illustrated in step S1 in FIG. 8, for example, the control unit 9 calculates the distance “D=d1” between the display device 1 and the positions of the right eye RE and the left eye LE of the user U1. In accordance with the positions of the right eye RE and the left eye LE and the calculated distance, the control unit 9 determines display so that left-eye images P1 and right-eye images P2 are alternately displayed on the display unit 4, as illustrated in step S1 in FIG. 8, for example. Although the left-eye images P1 and the right-eye images P2 are alternately displayed in the example in step S1 in FIG. 8, the left-eye images P1 and the right-eye images P2 may not be alternately displayed and may be displayed in any manner, as long as the user U1 can maintain parallax between the left eye LE and the right eye RE. The barrier control unit 7 then determines the unit regions 150 to be the transmissive regions 1501 and the unit regions 150 to be the light blocking regions 1502 among the respective unit regions 150 of the barrier unit 6, so that left-eye images P1 are viewed with the left eye LE of the user U1 via the barrier unit 6, and right-eye images P2 are viewed with the right eye RE of the user U1 via the barrier unit 6, among the left-eye images P1 and the right-eye images P2 alternately displayed on the display unit 4, as illustrated in step S1 in FIG. 8, for example.

Instep S1 in FIG. 8, under the control of the control unit 9, rows of pixels of left-eye images P1 formed with left-eye images P1 displayed in the Y-axis direction, and rows of pixels of right-eye images P2 formed with right-eye images P2 displayed in the Y-axis direction are alternately arranged in lines in the X-axis direction on the display surface 4S of the display unit 4, as illustrated in FIG. 9. In step S1 in FIG. 8, under the control of the barrier control unit 7, the regions through which light is to pass are determined from among the barrier unit 6 (from among the respective unit regions 150), so that the left-eye images P1 displayed on the display unit 4 are visually recognized with the left eye LE of the user U1 via the barrier unit 6, as illustrated in FIG. 10. Likewise, under the control of the barrier control unit 7, the unit regions 150 serving the transmissive regions 1501 and the unit regions 150 serving the light blocking regions 1502 are determined from among the barrier unit 6 (from among the respective unit regions 150), so that the right-eye images P2 displayed on the display unit 4 are visually recognized with the right eye RE of the user U1 via the barrier unit 6, as illustrated in FIG. 11.

The control unit 9 then calculates the distance between the display device 1 and the positions of the right eye RE and the left eye LE of the user U1. If the result differs from the distance to the positions of the right eye RE and the left eye LE calculated in step S1, the control unit 9 updates the display on the display unit 4. The barrier control unit 7 updates transmitting and blocking in the unit regions 150 of the barrier unit 6. Specifically, in accordance with the distance between the display device 1 and the positions of the right eye RE and the left eye LE of the user U1, the control unit 9 changes the display of the left-eye images P1 and the right-eye images P2 to be displayed on the display unit 4. The barrier control unit 7 changes the unit regions 150 to be the transmissive regions 1501 and the unit regions 150 to be the light blocking regions 1502 among the respective unit regions 150 of the barrier unit 6.

As illustrated in step S2 in FIG. 8, for example, the control unit 9 calculates the distance “D=d2” between the display device 1 and the positions of the right eye RE and the left eye LE of the user U1. In accordance with the positions of the right eye RE and the left eye LE and the calculated distance, the control unit 9 then changes the display of the left-eye images P1 and the right-eye images P2, as illustrated in step S2 in FIG. 8, for example. In accordance with the changed display and the positions of the right eye RE and the left eye LE of the user U1, the barrier control unit 7 determines the unit regions 150 to be the transmissive regions 1501 and the unit regions 150 to be the light blocking regions 1502 among the respective unit regions 150 of the barrier unit 6, so that the right-eye images P2 are viewed with the right eye RE of the user U1 via the barrier unit 6, and the left-eye images P1 are viewed with the left eye LE of the user U1 via the barrier unit 6.

In step S2 in FIG. 8, under the control of the control unit 9, the display of the left-eye images P1 and the right-eye images P2 to be displayed on the display unit 4 is changed as illustrated in FIG. 12. The barrier control unit 7 changes the unit regions 150 through which light is to pass among the respective unit regions 150 of the barrier unit 6. That is, in step S2 in FIG. 8, the rows of pixels of the left-eye images P1 and the rows of pixels of the right-eye images P2 in step S1 change places. Under the control of the barrier control unit 7, the unit regions 150 serving the transmissive regions 1501 and the unit regions 150 serving the light blocking regions 1502 are changed from among the barrier unit 6 (from among the respective unit regions 150), so that the left-eye images P1 displayed on the display unit 4 are visually recognized with the left eye LE of the user U1 via the barrier unit 6, as illustrated in FIG. 12. Likewise, under the control of the barrier control unit 7, the unit regions 150 serving the transmissive regions 1501 and the unit regions 150 serving the light blocking regions 1502 are changed in the barrier unit 6 (among the respective unit regions 150), so that the right-eye images P2 displayed on the display unit 4 are visually recognized with the right eye RE of the user U1 via the barrier unit 6, as illustrated in FIG. 12.

In this manner, in accordance with the distance between the display device 1 (the barrier unit 6) and the positions of the right eye RE and the left eye LE of the user U1, the control unit 9 changes the display of the left-eye images P1 and the right-eye images P2. In accordance with the left-eye images P1 and the right-eye images P2, the barrier control unit 7 changes the unit regions 150 to be the transmissive regions 1501 and the unit regions 150 to be the light blocking regions 1502. The display change method to be implemented by the control unit 9 in accordance with the distance between the display device 1 (the barrier unit 6) and the positions of the right eye RE and the left eye LE of the user U1 may be set beforehand by calibration in the designing stage based on the relationship between the position of the display device 1 and the positions of the right eye RE and the left eye LE, or may be calculated by real-time processing when the display device 1 is used.

As described above, in accordance with the positions of the right eye RE and the left eye LE of the user U1, the barrier control unit 7 determines the unit regions 150 to be the transmissive regions 1501 and the unit regions 150 to be the light blocking regions 1502 among the respective unit regions 150 of the barrier unit 6, so that the right-eye images P2 are viewed with the right eye RE of the user via the unit regions 150 of the barrier unit 6, and the left-eye images P1 are viewed with the left eye LE of the user via the unit regions 150 of the barrier unit 6. For example, after changing display, the barrier control unit 7 changes the unit regions 150 to be the transmissive regions 1501 and the unit regions 150 to be the light blocking regions 1502 among the respective unit regions 150 of the barrier unit 6 in accordance with the changed display. The flow of the control

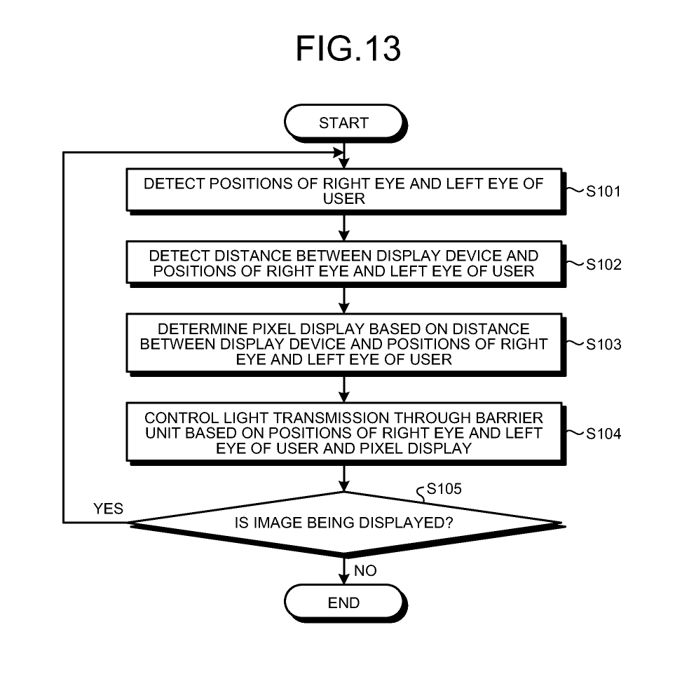

Referring now to FIG. 13, the flow of the control to be performed by the barrier control unit 7 and the control unit 9 according to this embodiment is described. FIG. 13 is a flowchart of the control according to this embodiment. The control illustrated in FIG. 13 is performed when display of a three-dimensional image is started, for example.

As illustrated in FIG. 13, the control unit 9 detects the positions of the right eye RE and the left eye LE of the user U1 from an image acquired by the imaging unit 8 (step S101). The control unit 9 then calculates the distance between the display device 1 and the positions of the right eye RE and the left eye LE of the user U1 (step S102).

The control unit 9 then determines display of right-eye images P2 and left-eye images P1 to be displayed on the display unit 4 based on the distance between the display device 1 and the positions of the right eye RE and the left eye LE (step S103). The barrier control unit 7 then controls transmitting and blocking of light through the barrier unit 6 based on the positions of the display device 1, the right eye RE, and the left eye LE, and the display (step S104). Specifically, the barrier control unit 7 determines the unit regions 150 to be the transmissive regions 1501 and the unit regions 150 to be the light blocking regions 1502 among the respective unit regions 150 of the barrier unit 6. The barrier unit 6 divides an image into images for the right eye and images for the left eye by blocking light. That is, the barrier unit 6 functions as the parallax forming unit that divides light between the display unit 4 and respective viewpoints with respect to a predetermined direction (the X-direction, for example) so that different lights reach the respective viewpoints (the right eye and the left eye, for example) from the display unit 4 because of light blocking.

The control unit 9 then determines whether an image is being displayed (step S105). If the determination result shows that an image is being displayed (Yes in step S105), the control unit 9 returns to step S101, and continues the control illustrated in FIG. 13. If the determination result shows that any image is not being displayed (No in step S105), the control unit 9 ends the control illustrated in FIG. 13. Although the control on the operation the barrier unit 6 is repeatedly performed while an image is being displayed according to the flow in FIG. 13 and the explanation of the flow, the control is merely an example and is not limited to the above. The position detection and the control on the operation of the barrier unit 6 while an image is being displayed may be skipped depending on the situation. For example, in a case where the differences between the positions of the right eye RE and the left eye LE of the user U1 acquired when step S101 is again carried out, and the positions of the right eye RE and the left eye LE of the user U1 at the time of the previous control performed on the operation of the barrier unit 6 are larger than predetermined threshold values, the unit regions 150 to be the transmissive regions 1501 and the unit regions 150 to be the light blocking regions 1502 may be redetermined among the respective unit regions 150 of the barrier unit 6. The predetermined threshold values relate to display of the three-dimensional image, and depends on changes in the positions of the right eye RE and the left eye LE of the user U1 that require changes in the positions of the transmissive regions 1501 and the light blocking regions 1502.

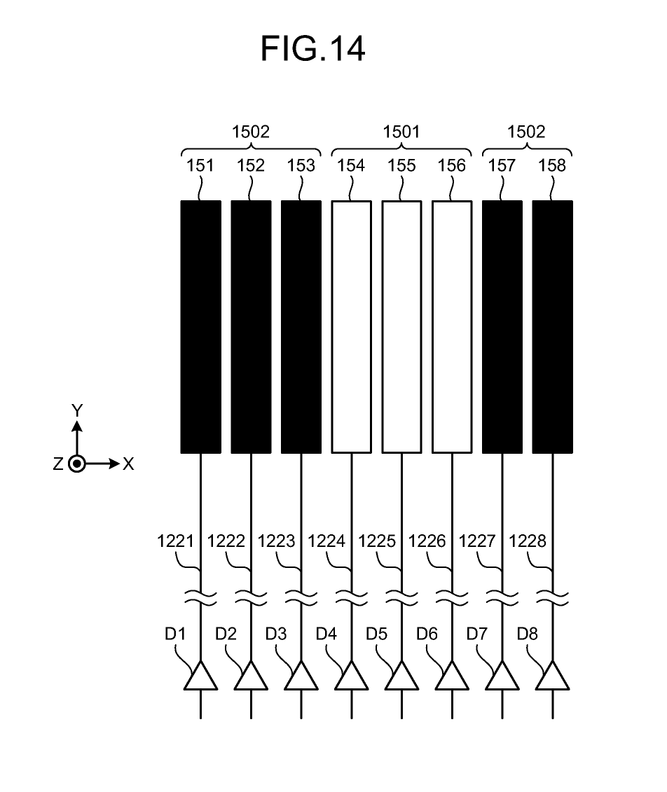

Referring now to FIG. 14, the structure of the barrier unit 6 is described. FIG. 14 is a diagram illustrating an example structure of the barrier unit 6. The barrier unit 6 is formed with unit regions. As illustrated in FIG. 14, the barrier unit 6 includes unit regions 151 through 158, for example. In the barrier unit 6, signal lines 1221 through 1228 are provided for the respective unit regions 151 through 158. The signal lines 1221 through 1228 are coupled to corresponding unit region electrodes 122. The light transmissive state of the unit regions 151 through 158 is set by voltage applied to the signal lines 1221 through 1228. That is, the unit regions 151 through 158 are put into a light transmissive state or a light non-transmissive (light blocking) state by voltage applied to the signal lines 1221 through 1228. The unit regions 150 (151 through 158) in the light transmissive state serve as the transmissive regions 1501, and the unit regions 150 (151 through 158) in the light non-transmissive (light blocking) state serve as the light blocking regions 1502.

As illustrated in FIG. 14, driver circuits D1 through D8 that apply voltages are coupled to the signal lines 1221 through 1228 corresponding to the unit regions 151 through 158 constituting the barrier unit 6. Under the control of the barrier control unit 7, the driver circuits D1 through D8 selectively output a voltage Vl (0 V, for example) for setting the light transmissive state, and a voltage Vh (5 V, for example) for setting the light non-transmissive (light blocking) state. The driver circuits D1 through D8 may be three-state buffers, for example, but are not limited to them.

As illustrated in FIG. 14, the driver circuits D1 through D8 that apply voltages are coupled to the signal lines 1221 through 1228 corresponding to the unit regions 151 through 158 constituting the barrier unit 6. The voltage Vh for setting the light non-transmissive (light blocking) state is output and applied to the unit regions 151, 152, 153, 157, and 158 from the driver circuits D1, D2, D3, D7, and D8. The voltage Vl for setting the light transmissive state is output and applied to the unit regions 154, 155, and 156 from the driver circuits D4, D5, and D6.

### Minimum Units of the Division

Next, the minimum units of light to be divided by the barrier unit 6 are described. FIG. 15 is a diagram illustrating an example of a light blocking pattern and a light transmitting pattern of the barrier unit 6 in a case where the color pixels illustrated in FIG. 6 are successively arranged in the X-direction. As illustrated in FIG. 15, each of the pixels in this embodiment is a rectangle whose longitudinal direction is the Y-direction, and the width of each of the pixels in the X-direction (the width a in FIG. 15) is smaller than the width in the Y-direction (the width b in FIG. 15). The pixels in this embodiment are designed so that each unit pixel 5 formed with three pixels R, G, and B adjacent to one another in the X-direction have substantially a square region.

In the description below, each portion that is located between light blocking portions of the barrier unit 6 and allows light to pass therethrough will be referred to as an “opening”, and the width of each opening in the X-direction (the width c in FIG. 15, for example) will be referred to as the “opening width”. The width of each pixel in the display unit 4 has a correlation with the width of each portion that allows light to pass through the barrier unit 6. Specifically, the opening width of each opening is seven- to eight-tenths of the width of each light transmissive pixel in the X-direction, for example. Therefore, if the width of one pixel is 20 micrometers (μm) in the X-direction, the width of the opening formed to allow only the light from this one pixel to pass therethrough is 14 to 16 μm in the X-direction. If the width of one pixel is smaller than 20 μm in the X-direction, the width of the opening is even smaller in the X-direction.

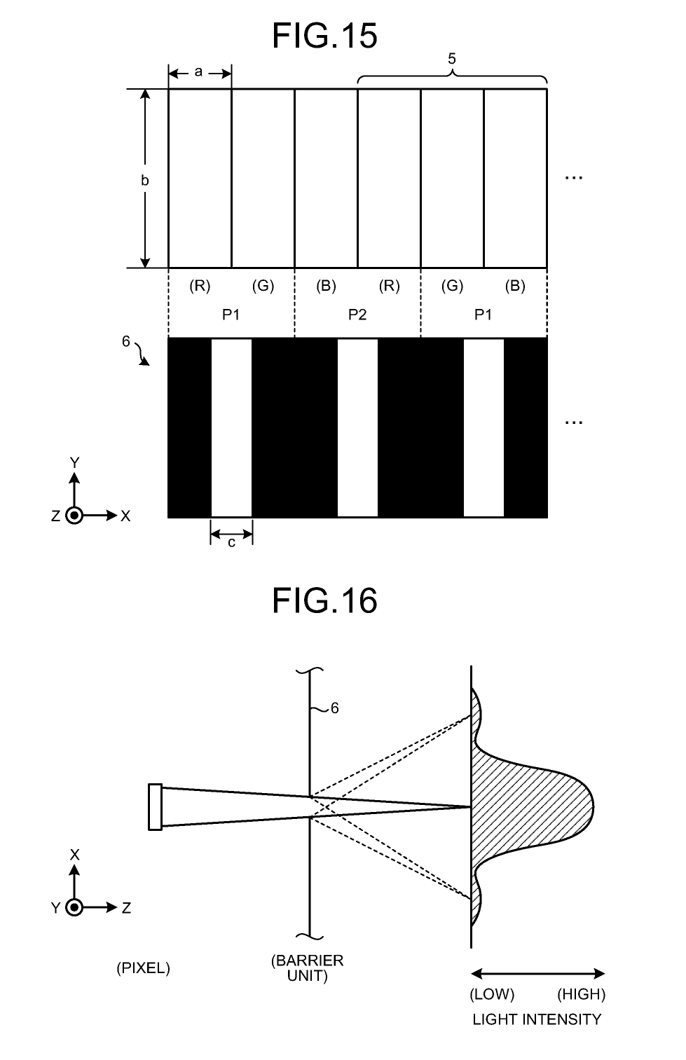

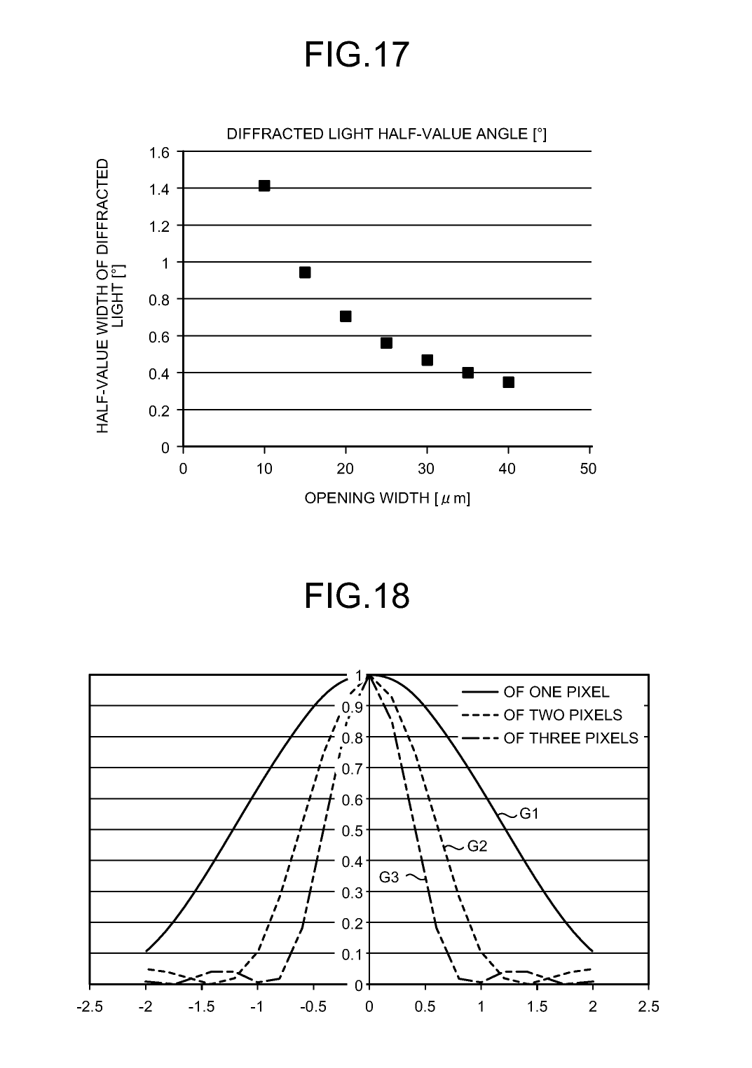

If the width of each portion that allows light to pass through the barrier unit 6 becomes smaller than 15 μm in the X-direction, light diffraction at the barrier unit 6 becomes more noticeable. FIG. 16 is a diagram illustrating an example of diffracted light intensity in diffraction that occurs at an opening. FIG. 17 is a graph illustrating an example of the relationship between the width of an opening in the X-direction and the diffracted light half-value angle. As illustrated in FIG. 16, light that is emitted from the pixel side of the display unit 4 toward the viewpoint side is diffracted at an opening of the barrier unit 6. In a case where diffraction occurs, the light emitted from the pixel side diffuses on the viewpoint side, as illustrated in the diffracted light intensity in FIG. 16. The degree of diffusion is greater when the width of the opening in the X-direction is smaller. As illustrated in FIG. 17, the degree of diffusion becomes more noticeable when the width of the opening in the X-direction is smaller than 15 μm. A larger diffracted light half-value angle means a greater degree of light diffusion due to diffraction. In this case, an image overlap phenomenon occurs more often.

FIG. 18 is a diagram illustrating an example of the correspondence relationship between the number of pixels from which light is guided by one opening, and the angle distribution of diffracted light due to diffraction that occurs in this light. In a case where the width of one pixel is 18 μm in the X-direction, for example, the width of the opening corresponding to the one pixel is smaller than 15 μm in the X-direction. The diffracted light generated by the opening formed to allow only the light from one pixel to pass therethrough has an angle distribution G1 illustrated in FIG. 18. The diffracted light half-value width of the angle distribution G1 is 1 degree or greater. If the number of pixels from which light is guided by one opening is larger than one, the width of each opening of the barrier unit 6 in the X-direction increases with the number of pixels. For example, in a case where light is guided from pixels adjacent to each other in the X-direction by one opening, the width of the one opening in the X-direction becomes greater. Specifically, in a case where the width of each pixel is 18 μm in the X-direction, the total width of two adjacent pixels is 36 μm in the X-direction. The width of the opening that allows light from the two pixels to pass threrethrough is greater than 25 μm in the X-direction. The diffracted light generated from the opening in this case has an angle distribution G2 illustrated in FIG. 18. The diffracted light half-value width of the angle distribution G2 is smaller than 1 degree. Diffracted light generated from an opening that allows light from three pixels to pass therethrough has an angle distribution G3 illustrated in FIG. 18, and the diffracted light half-value width is even smaller than the above.

In a case where the width of each pixel in a predetermined direction (the X-direction, for example) is equal to or smaller than a predetermined width, the barrier unit 6 of this embodiment divides light beams between the display unit 4 and respective viewpoints (the viewpoint of the right eye and the viewpoint of the left eye, for example) so that light from more than one pixel is included in each minimum divisional unit region. The “predetermined width” is the width of a pixel with which an image overlap phenomenon at a visible level occurs due to diffracted light generated, in a case where openings each having a width to allow light from one pixel to pass therethrough are formed based on the relationship between the width of a pixel in a predetermined direction and the width of each opening (1:0.7 to 0.8, for example).

In a case where the width of a pixel in the X-direction is smaller than 20 μm, for example, the barrier unit 6 of this embodiment divides light beams between the display unit 4 and the respective viewpoints of the right eye and the left eye with respect to the X-direction, so that light from two or more pixels is guided by one opening. Specifically, if the width of a pixel in the X-direction is 20 μm or greater, the number of pixels from which light is guided by one opening is “1”. If the width of a pixel in the X-direction is not smaller than 9.375 μm but is smaller than 20 μm, the number of pixels from which light is guided by one opening is “2”. In this specific example, the number of pixels from which light is guided by one opening is set so that the width of an opening in the X-direction becomes 15 μm or greater in a case where the relationship between the width of a pixel in the predetermined direction and the width of an opening is 1:0.8. If the width of a pixel in the X-direction is not smaller than 6.25 μm but is smaller than 9.375 μm in this case, the number of pixels from which light is guided by one opening is “3”.

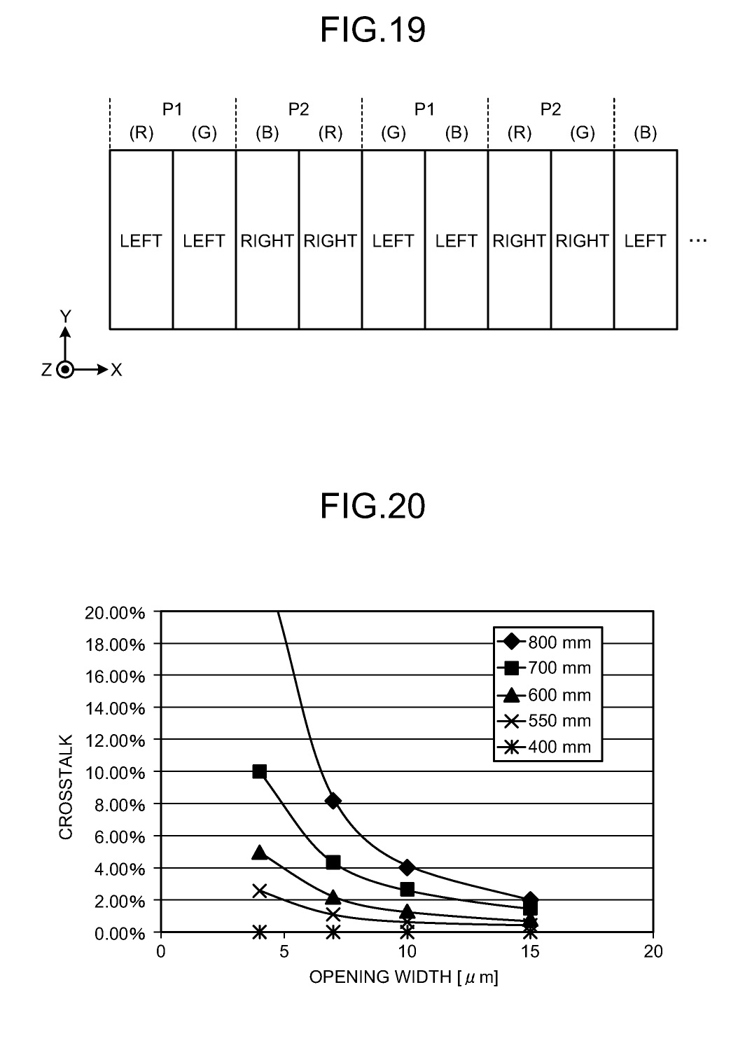

FIG. 19 is a diagram illustrating an example of an arrangement pattern of images for the right eye and images for the left eye in a case where the number of pixels included in each minimum divisional unit region is two. In FIG. 19 and FIGS. 22 through 25, which will be described later, “RIGHT” indicates placement of an image for the right eye, and “LEFT” indicates placement of an image for the left eye. The example illustrated in FIG. 19 corresponds to the pixel arrangement pattern illustrated in FIG. 15. A “minimum divisional unit region” in this embodiment is a region in which light from one row of pixels arranged in the X-direction is guided by one opening. In a case where the number of pixels included in a minimum divisional unit region is two, the control unit 9 determines pixel display so that two pixels of left-eye images P1 and two pixels of right-eye images P2 are alternately displayed on the display unit 4, as illustrated in FIG. 19.

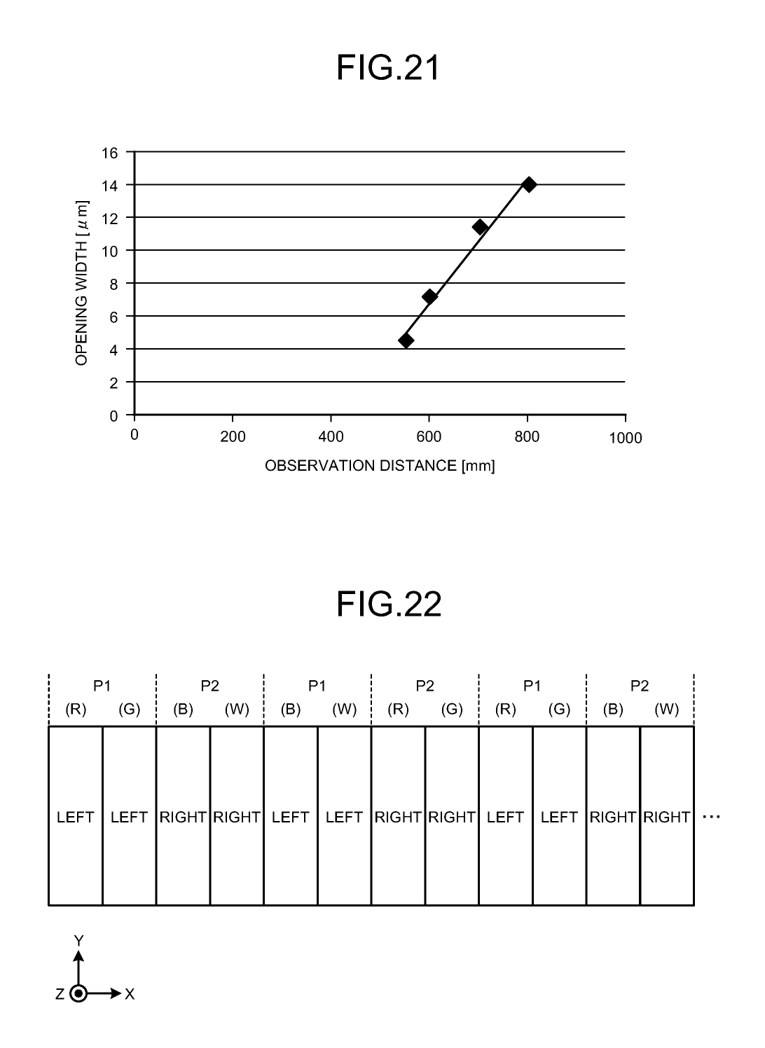

FIG. 20 is a graph illustrating an example of the correspondence relationship between the distance from the display device 1 (the barrier unit 6) to the viewpoints (the positions of the right eye RE and the left eye LE of the user U1, for example) and occurrence of an image overlap phenomenon. The curves of “400 mm to 800 mm” in FIG. 20 indicate the correspondence relationship between the opening width in the distance represented by the respective numerical values from the display unit 4 to the viewpoints, and occurrence of an image overlap phenomenon. When the value of “crosstalk” indicated in FIG. 20 is 2.00% or smaller, a three-dimensional image can be clearly viewed at the viewpoints, and influence of image overlap can be substantially ignored. FIG. 21 is a graph illustrating an example of the correspondence relationship between the distance from the display device 1 (the barrier unit 6) to the viewpoints and the width of the smallest opening width that can prevent image overlap phenomena. As illustrated in FIGS. 20 and 21, there is a correlation between the distance from the display device 1 to the viewpoints and the degree of occurrence of an image overlap phenomenon. Specifically, where the distance between the display device 1 and the viewpoints is longer, the image overlap phenomenon accompanying a reduction in the opening width (the width in the X-direction, for example) of each opening becomes more noticeable. Where the distance between the display device 1 and the viewpoints is shorter, an image overlap phenomenon does not easily occur.

In a specific example case where the distance between the display device 1 and the viewpoints is 600 mm or shorter, an image overlap phenomenon at a visible level does not occur, even if the opening width of each opening is 10 μm. In a case where any image overlap phenomenon does not reach a visible level, the user U1 can clearly view a three-dimensional image. Therefore, there are cases where the opening width of each opening may be smaller than 15 μm, depending on the distance between the display device 1 and the viewpoints.

More specifically, the degree of light diffusion due to diffraction depends on the distance between the parallax forming unit (the barrier unit 6, for example) provided in the display device 1 and the viewpoints. Therefore, the barrier control unit 7 may determine the opening width of each opening in accordance with the distance between the parallax forming unit (the barrier unit 6, for example) and the viewpoints. Specifically, the barrier control unit 7 controls transmitting and blocking in the respective unit regions 150 (the unit regions 151 through 158, for example) of the barrier unit 6 based on the distance between the display device 1 (the barrier unit 6) and the positions of the right eye RE and the left eye LE of the user U1 detected from an image of the user U1 captured by the imaging unit 8. Unit regions 150 that are in the light transmissive state which exist between unit regions 150 that block light function as an opening. That is, in a case where adjacent unit regions 150 are in the light transmissive state, the adjacent unit regions 150 function as one opening. The barrier control unit 7 determines the number of adjacent unit regions 150 that are put into the light transmissive state to function as one opening, based on the distance between the display device 1 (the barrier unit 6) and the positions of the right eye RE and the left eye LE of the user U1 detected from an image of the user U1 captured by the imaging unit 8. Specifically, in the process in step S104 of the flowchart illustrated in FIG. 13, the barrier control unit 7 controls transmitting and blocking of light in the respective unit regions 150 of the barrier unit 6, taking into account the number of adjacent unit regions 150 that are put into the light transmissive state to function as one opening.

The width of each of the unit regions 150 of the barrier unit 6 in the predetermined direction (the X-direction, for example) may be smaller than the predetermined width. In an example case where the width of each pixel in the X-direction is 15 μm, the width of each of the unit regions 150 of the barrier unit 6 in the X-direction is 11 μm to 12 μm based on the relationship between the width of each pixel in the predetermined direction and the width of each opening (1:0.7 to 0.8, for example). If the distance between the display device 1 (the barrier unit 6) and the positions of the right eye RE and the left eye LE of the user U1 detected from an image of the user U1 captured by the imaging unit 8 is 600 mm or shorter, for example, the barrier control unit 7 determines that the number of unit regions 150 to be put into the light transmissive state to function as one opening is one. That is, at this distance, the user U1 can clearly view the three-dimensional image even though each opening has an opening width equivalent to one pixel. Therefore, the barrier control unit 7 adjusts the opening width of each opening to the width equivalent to one pixel. In this case, the image has higher definition. If the distance between the display device 1 (the barrier unit 6) and the positions of the right eye RE and the left eye LE of the user U1 detected from an image of the user U1 captured by the imaging unit 8 is longer than 600 mm, on the other hand, the barrier control unit 7 determines that the number of unit regions 150 to be put into the light transmissive state to function as one opening is two, so as to adjust the opening width of each opening to a width of 15 μm or greater. As a result, occurrence of an image overlap phenomenon can be prevented. In this manner, the barrier unit 6 of this embodiment functions as the switching unit that can switch between light blocking and light transmission for each unit width smaller than the predetermined width. The barrier control unit 7 of this embodiment functions as the switch control unit that controls each part of the switching unit to switch between light transmission and light blocking in accordance with the distance between the parallax forming unit and the viewpoints. The above described relationship between the distance from the display device 1 (the barrier unit 6) to the positions of the right eye RE and the left eye LE of the user U1, and the number of successive unit regions 150 to allow light to pass therethrough is merely an example, and can be changed as appropriate. In a case where the width of each unit region 150 of the barrier unit 6 in the X-direction is smaller, for example, finer control can be performed on the opening width.

As described above, according to this embodiment, when the width of each pixel in a predetermined direction (the X-direction, for example) is equal to or smaller than a predetermined width, the parallax forming unit (the barrier unit 6, for example) divides light beams between the display unit 4 and respective viewpoints (the right eye and the left eye, for example) so that light from plural pixels is included in a minimum divisional unit region. Accordingly, an image can be divided into minimum divisional unit regions to prevent occurrence of an image overlap phenomenon due to diffraction, regardless of the width of each pixel. Thus, image overlap phenomena can be more effectively prevented. An image can be divided into minimum divisional unit regions so that occurrence of image overlap phenomena due to diffraction can be prevented, regardless of the width of each pixel. Accordingly, the width of each pixel can be set, regardless of the minimum divisional unit regions. Increase in the definition of the display unit 4 is not limited due to a three-dimensional image. In this manner, the display device can have higher definition while preventing image overlap phenomena.

As the width of each minimum divisional unit region in the predetermined direction depends on the distance between the parallax forming unit and the viewpoints, the width of each minimum divisional unit region in the predetermined direction can be further reduced with respect to viewpoints at a short distance (600 mm or shorter, for example) at which the range of light diffusion due to diffraction becomes smaller. Accordingly, a higher-definition image can be provided for viewpoints at a short distance.

As the switching unit switches between light transmission and light blocking for each unit in accordance with the distance between the parallax forming unit and the viewpoints, image light can be divided into minimum divisional unit regions with the minimum width in the predetermined direction so as to prevent image overlap phenomena at the distance. That is, the display device can have higher definition while preventing image overlap phenomena.

As the width of each minimum divisional unit region in the predetermined direction is 15 μm or greater, image overlap phenomena can be prevented, regardless of the distance between the parallax forming unit and the viewpoints. Modifications

Referring now to FIGS. 22 through 25, modifications (first through fourth modifications) of the present invention are described. In the description of each of the modifications, the same components as those of the above described embodiment are denoted by the same reference numerals as those used in the above described embodiments, and explanation of them are not repeated. Display devices 1 according to the first through fourth modifications each have the same structure as the above described embodiment, except for the features related to the pixels of the display unit 4, which will be described below with reference to FIGS. 22 through 25. In the description of the modifications below, the display control to be performed by the control unit 9 is explained, and the control to be performed by the barrier control unit 7 on the barrier unit 6 corresponds to the display control in the respective modifications.

### First Modification

FIG. 22 is a diagram illustrating an example of an arrangement pattern of images for the right eye and images for the left eye in a case where each unit pixel is formed with pixels R, G, B, and W. A “minimum divisional unit region” in the first modification is a region in which light from one row of pixels arranged in the X-direction is guided by one opening as in the above described embodiment. In the first modification, when the number of pixels included in each minimum divisional unit region is two, the control unit 9 determines pixel display so that two pixels of left-eye images P1 and two pixels of right-eye images P2 are alternately displayed on the display unit 4, as illustrated in FIG. 22.

According to the first modification, a higher luminance by virtue of white (W) can be achieved in addition to the same effects as those of the above described embodiment. The first modification can also be applied in a case where a sub pixel representing not white (W) but a complementary color for widening the color reproduction range is added to each unit pixel. In this case, a structure according to the first modification can not only achieve the same effects as those of the above described embodiment, but also widen the color reproduction range with the complementary color. In this manner, the first modification can cope with sub pixels of four or more colors constituting unit pixels.

### Second Modification

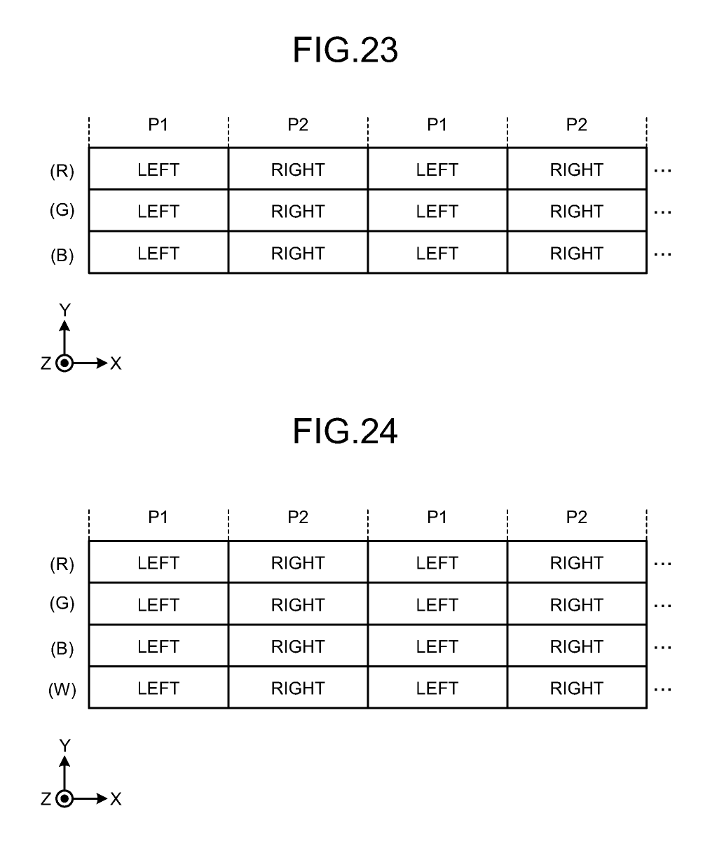

FIG. 23 is a diagram illustrating another example of an arrangement pattern of images for the right eye and images for the left eye in a case where each unit pixel is formed with pixels R, G, and B. The pixels of the display unit 4 in the second modification are arranged so that the width of each pixel in a predetermined direction (the X-direction, for example) becomes greater than the width of each pixel in a direction (the Y-direction, for example) perpendicular to the predetermined direction. In other words, the arrangement of the pixels in the second modification is the arrangement obtained by rotating the unit pixels of the above described embodiment 90 degrees in the X-Y plane. In the second modification, when at least either the width of each pixel in the predetermined direction or the width of each pixel in the direction perpendicular to the predetermined direction is equal to or smaller than the predetermined width, the pixels are arranged so that the width of each pixel in the predetermined direction becomes longer than the width of each pixel in the direction perpendicular to the predetermined direction. In this manner, the width of each pixel in the predetermined direction is made greater. As a result, the opening width becomes an width corresponding to the width of each pixel in the longitudinal direction. In this case, even if the width of each pixel in the direction (the Y-direction, for example) perpendicular to the predetermined direction is approximately 20 μm, for example, the width of each pixel in the predetermined direction (the X-direction, for example) is approximately 60 μm. Accordingly, the opening width may be greater than 40 μm. As described above, the second modification can not only achieve the same effects as those of the above described embodiment, but also have a higher degree of freedom in setting the opening width by arranging the pixels so that the width of each pixel in the predetermined direction (the X-direction, for example) becomes greater than the width of each pixel in the direction (the Y-direction, for example) perpendicular to the predetermined direction. As the longitudinal direction of the pixels is adjusted to the predetermined direction, a higher definition can be realized without a reduction in the opening width, and the higher definition can be achieved while image overlap phenomena are prevented.

A “minimum divisional unit region” in the second modification is a region in which light from one of the unit pixels arranged in the X-direction is guided by one opening. That is, in the case of the pixel arrangement illustrated in FIG. 23, light from three pixels R, G, and B arranged in the Y-direction is included in each minimum divisional unit region. Therefore, the control unit 9 of the second modification determines pixel display so that one unit pixel of left-eye images P1 and one unit pixel of right-eye images P2 are alternately displayed on the display unit 4, as illustrated in FIG. 23. As described above, in a case where the width of each pixel in the direction (the Y-direction, for example) perpendicular to the predetermined direction is equal to or smaller than the predetermined width, the parallax forming unit (the barrier unit 6, for example) divides light beams between the display unit 4 and the respective viewpoints (the right eye and the left eye, for example) so that light from more than one pixel (the pixels constituting one of the unit pixels arranged in the X-direction, for example) is included in a minimum divisional unit region.

### Third Modification

FIG. 24 is a diagram illustrating another example of an arrangement pattern of images for the right eye and images for the left eye in a case where each unit pixel is formed with pixels R, G, B, and W. The pixels of the display unit 4 in the third modification are arranged so that the width of each pixel in a predetermined direction (the X-direction, for example) becomes greater than the width of each pixel in a direction (the Y-direction, for example) perpendicular to the predetermined direction, as in the second modification. In other words, the arrangement of the pixels in the third modification is the arrangement obtained by rotating the unit pixels of the first modification 90 degrees in the X-Y plane. A “minimum divisional unit region” in the third modification is a region in which light from one of the unit pixels arranged in the X-direction is guided by one opening, as in the second modification. The control unit 9 of the third modification determines pixel display so that one unit pixel of left-eye images P1 and one unit pixel of right-eye images P2 are alternately displayed on the display unit 4, as illustrated in FIG. 24.

According to the third modification, a higher luminance by virtue of white (W) can be achieved in addition to the same effects as those of the second modification. Like the first modification, the third modification can also be applied in a case where a sub pixel representing not white (W) but a complementary color for widening the color reproduction range is added to each unit pixel. Fourth modification

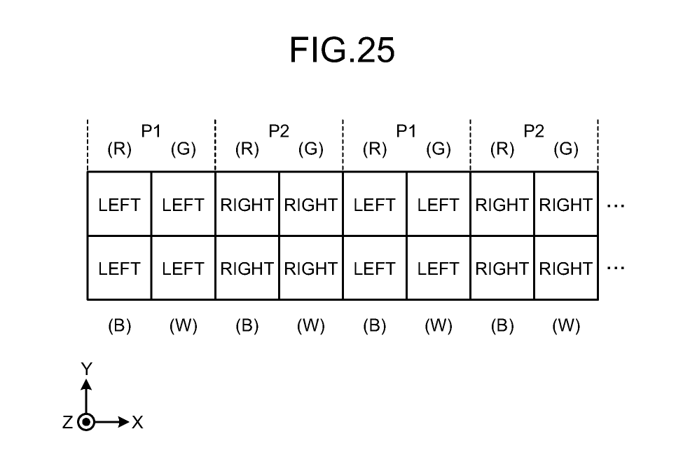

FIG. 25 is a diagram illustrating an example of an arrangement pattern of images for the right eye and images for the left eye in a case where each unit pixel is formed with 2×2 pixels. As for the pixels of the display unit 4 in the fourth modification, each unit pixel is formed with 2×2 pixels arranged in a predetermined direction (the X-direction, for example) and a direction (the Y-direction, for example) perpendicular to the predetermined direction, as illustrated in FIG. 25. In the 2×2 arrangement in FIG. 25, the upper left pixel is red (R), the upper right pixel is green (G), the lower left pixel is blue (B), and the lower right pixel is white (W). However, this is an example of arrangement and can be changed as appropriate, and this modification is not limited to this arrangement. If the width of the 2×2 pixels in a predetermined direction (the width of 1×2 pixels) is equal to or smaller than the predetermined width in this case, the parallax forming unit (the barrier unit 6, for example) divides light beams between the display unit 4 and respective viewpoints (the viewpoint of the right eye and the viewpoint of the left eye, for example) so that light from n (n≧2)×2 pixels is included in each minimum divisional unit region. If the width (the width of 1×2 pixels) in the predetermined direction is equal to or smaller than the predetermined width, the control unit 9 of the fourth modification determines pixel display so that one unit pixel of left-eye images P1 and one unit pixel of right-eye images P2 are alternately displayed on the display unit 4, as illustrated in FIG. 25. A “minimum divisional unit region” corresponding to the pixel display illustrated in FIG. 25 is a region in which light from one of the unit pixels arranged in the X-direction is guided by one opening. However, this is merely an example, and this modification is not limited to this. For example, the number of pixels in the Y-direction in each “minimum divisional unit region” may be one.

According to the fourth modification, not only the same effects as those of the above described embodiment are achieved, but also image light can be divided into minimum divisional unit regions so that image overlap phenomena can be prevented even in a case where each unit pixel is formed with pixels arranged in the predetermined direction and the direction that is parallel to the screen of the display unit 4 and is perpendicular to the predetermined direction.

### Method of Manufacturing

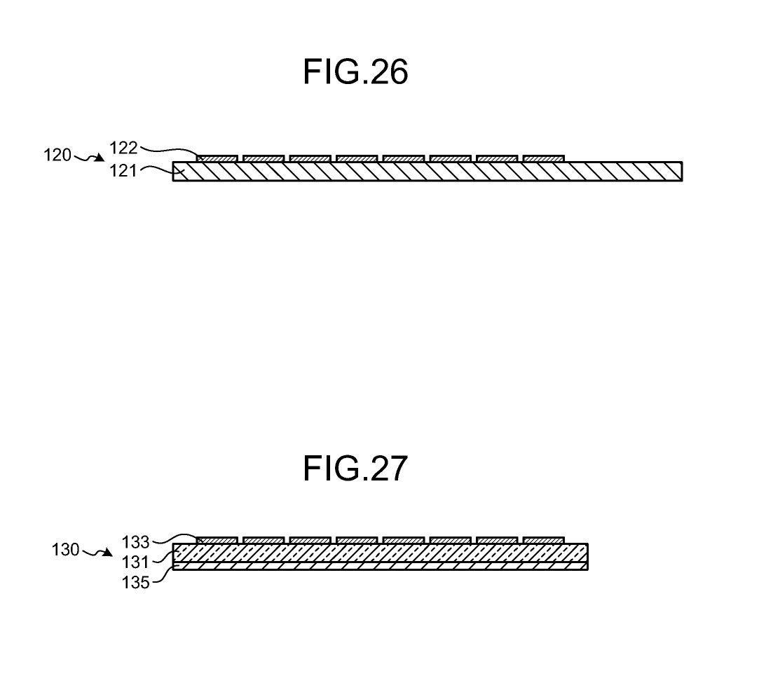

Next, an example method of manufacturing the barrier unit 6 is described. FIGS. 26 through 31 are diagrams illustrating the example method of manufacturing the barrier unit 6. As illustrated in FIG. 26, the unit region electrodes 122 corresponding to the adjustment units (the unit regions 150) of the barrier unit 6 are formed on a surface of the substrate 121, to create a unit region substrate 120.

As illustrated in FIG. 27, the drive electrodes 133 are formed on a surface of the glass substrate 131. The polarizer 135 is then provided on the opposite side of the glass substrate 131 from the drive electrodes 133.

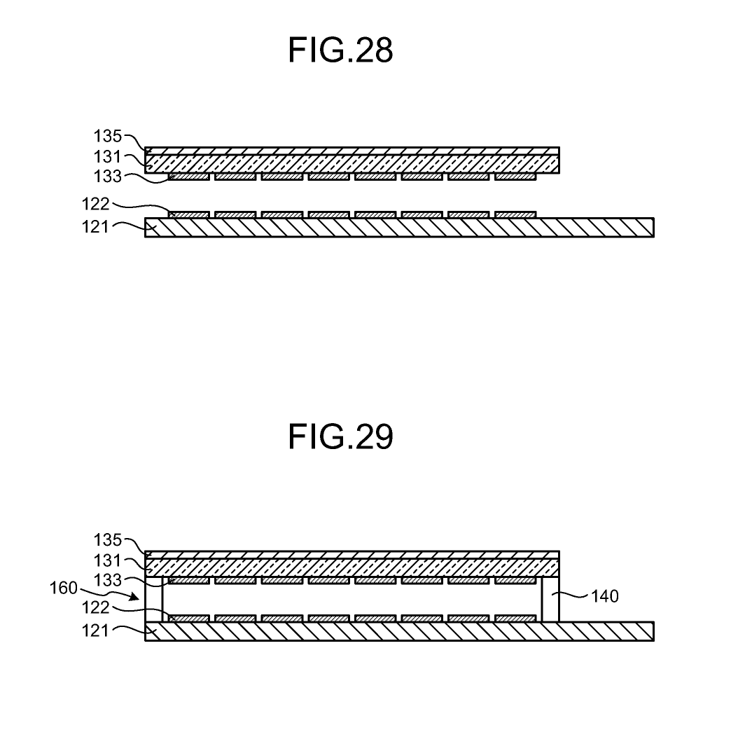

A counter substrate 130 and the unit region substrate 120 created as above are bonded to each other. A sealing material having a certain resistance value is applied to the peripheral portion of the unit region substrate 120, for example, and the counter substrate 130 reversed as illustrated in FIG. 28 and the unit region substrate 120 are bonded to each other, with the sealing material serving as the adhesive material. The sealing material is not applied to part of the peripheral portion of the unit region substrate 120, and this part is to form the inlet (not illustrated) for liquid crystal injection.

FIG. 29 illustrates a situation where the unit region substrate 120 and the counter substrate 130 are bonded to each other. As illustrated in FIG. 29, the unit region substrate 120 and the counter substrate 130 are bonded to each other with the sealing material 140.

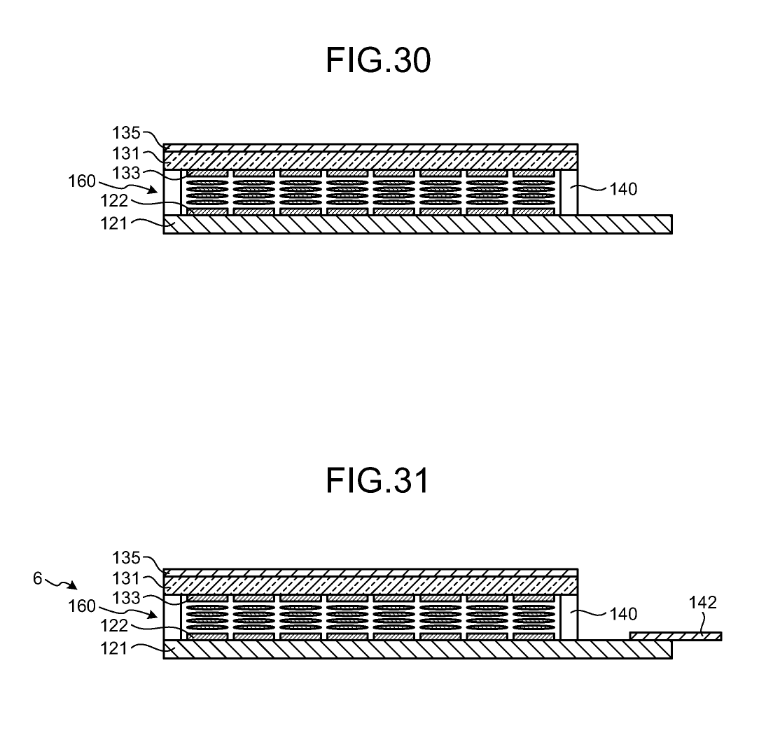

As illustrated in FIG. 30, liquid crystal is then injected into the space between the unit region electrodes 122 and the drive electrodes 133, to form the liquid crystal layer 160. The liquid crystal is injected through the inlet (not illustrated). After the liquid crystal is injected, the inlet (not illustrated) for liquid crystal injection is sealed with a sealing member (not illustrated). Lastly, a flexible cable 142 is attached as illustrated in FIG. 31. In this manner, the barrier unit 6 is obtained. The manufacturing method described herein is merely an example, and some other manufacturing method may be employed. For example, the one drop fill (ODF) method may be employed.

The barrier unit 6 manufactured as above and the display unit 4 are bonded to each other, so that the display device 1 illustrated in FIG. 4 is obtained.

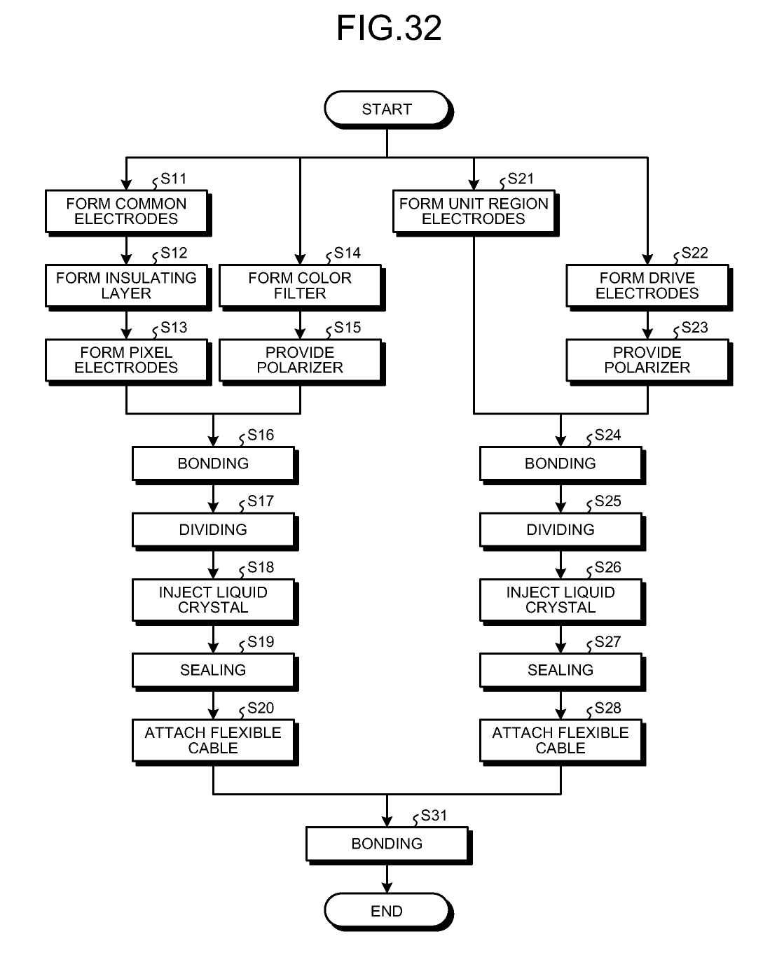

Referring now to FIG. 32, a method of manufacturing the display device 1 according to this embodiment is described. FIG. 32 is a flowchart illustrating the method of manufacturing the display device 1 according to this embodiment.

In step S11, the common electrodes COML are formed on a surface of the TFT substrate 21. In step S12, the insulating layer 24 is formed on the common electrodes COML. In step S13, the pixel electrodes 22 corresponding to the pixels of the display unit 4 are formed on the insulating layer 24. Through the above procedures, the pixel substrate 20 is obtained. The formation order of the pixel electrodes 22 and the common electrodes COML may be reversed. In that case, the common electrodes COML are located closer to the display surface than the pixel electrodes 22.

In step S14, the color filter 32 is formed on a surface of the glass substrate 31. In step S15, the polarizer 35 is provided on the opposite surface of the glass substrate 31 from the color filter 32. Through the above procedures, the counter substrate 30 is obtained. The color filter may be formed on the pixel substrate side.

In step S16, the sealing material 40 is applied to the pixel substrate 20, the counter substrate 30 is reversed, and the pixel substrate 20 and the counter substrate 30 are then bonded to each other. The sealing material 40 is not applied to a portion, and the portion is to be the liquid crystal inlet.

In a case where display devices are manufactured at the same time, the structure obtained in this stage is divided into respective display devices in step S17. In step S18, liquid crystal is injected through the liquid crystal inlet. In step S19, the liquid crystal inlet is filled with a sealing member, so that the liquid crystal is sealed. In step S20, a flexible cable 42 is attached. Through the above procedures, the display unit 4 is obtained.

In step S21, the unit region electrodes 122 are formed on a surface of the substrate 121, so that the unit region substrate 120 is obtained. In step S22, the drive electrodes 133 are formed on a surface of the glass substrate 131. In step S23, the polarizer 135 is provided on the opposite surface of the glass substrate 131 from the drive electrodes 133. Through the above procedures, the counter substrate 130 is obtained.

In step S24, the sealing material 140 is applied to the unit region substrate 120, the counter substrate 130 is reversed, and the unit region substrate 120 and the counter substrate 130 are then bonded to each other. The sealing material 140 is not applied to a portion, and the portion is to be the liquid crystal inlet.

In a case where display devices are manufactured at the same time, the structure obtained in this stage is divided into respective display devices in step S25. In step S26, liquid crystal is injected through the liquid crystal inlet. In step S27, the liquid crystal inlet is filled with a sealing member, so that the liquid crystal is sealed. In step S28, the flexible cable 142 is attached. Through the above procedures, the barrier unit 6 is obtained.

In step S31, the display unit 4 and the barrier unit 6 are bonded to each other with an adhesive agent, for example. Through the above process, the display device 1 is obtained.

The above described manufacturing method is a manufacturing method by which the display unit 4 that displays an image is formed (steps S11 through S20 in FIG. 32), and the parallax forming unit that determines display of the right-eye images P2 and the left-eye images P1 to be displayed on the display unit 4, and puts some of the unit regions 150 of the parallax forming unit (the barrier unit 6) into a light transmissive state in accordance with the positions of the right eye and the left eye and the display is formed (steps S21 through S28 in FIG. 32). This manufacturing method is merely an example, and the embodiment is not limited to this method. The method of manufacturing the display device described herein is an example method for forming the pixel electrodes 22 corresponding to the pixels of the display unit 4, and forming the unit region electrodes 122 corresponding to the adjustment units (the unit regions 150) of the barrier unit 6.

### EXAMPLES OF APPLICATIONS

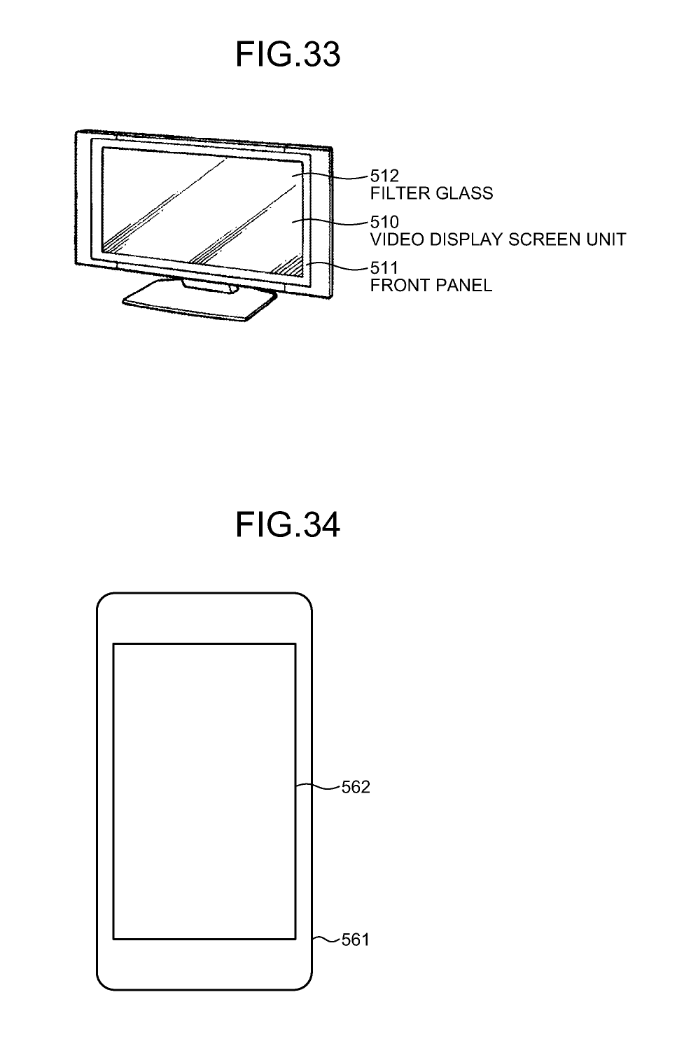

Referring now to FIGS. 33 and 34, examples of applications of the display devices 1 described in the above embodiment and the above modifications are described. FIGS. 33 and 34 are diagrams illustrating examples of electronic apparatuses in which the display device 1 according to this embodiment is used. The display devices 1 according to this embodiment and the modifications can be used in electronic apparatuses in various fields such as television devices, digital cameras, notebook-size personal computers, portable terminals devices such as portable telephones, and video cameras. In other words, the display devices 1 according to this embodiment and the modifications can be used in electronic apparatuses in various fields for displaying video signals input from outside or video signals generated inside as images or video images. First example of application

The electronic apparatus illustrated in FIG. 33 is a television device in which a display device 1 according to this embodiment or one of the modifications is used. This television device includes a video display screen unit 510 including a front panel 511 and filter glass 512, for example, and the video display screen unit 510 is a display device 1 according to this embodiment or one of the modifications.

### SECOND EXAMPLE OF APPLICATION

The electronic apparatus illustrated in FIG. 34 is a portable information terminal that functions as a portable computer, a multifunctional portable telephone, a portable computer that can perform audio communication, or a portable computer that can perform communication, and is called a smartphone or a tablet terminal. This portable information terminal has a display unit 562 on a surface of a housing 561, for example. This display unit 562 is a display device 1 according to this embodiment or one of the modifications. Others

Although the present disclosure has been described through an embodiment and example applications to electronic apparatuses, the present disclosure is not limited to the embodiment and the examples, and various modifications can be made to them.

For example, the parallax forming unit is not limited to a liquid crystal display like the barrier unit 6. Specifically, the parallax forming unit may be a plate-like structure including shielding portions that shield light and light transmissive portions (openings that are holes or the like formed in the plate, for example) that allow light to pass therethrough. In this case, the positions of the shielding portions and the light transmissive portions are determined in accordance with predetermined viewpoints and the distance between the display unit 4 and the respective viewpoints.

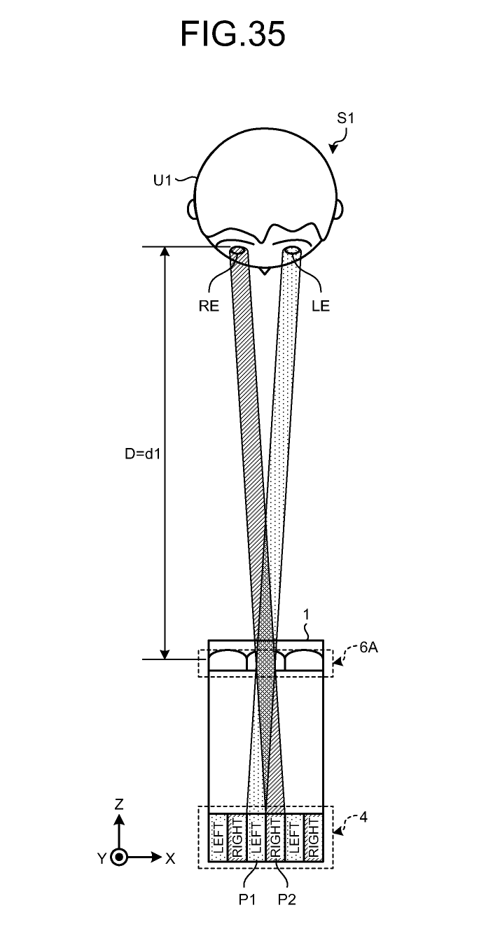

The parallax forming unit may divide image light and guide the divided light to respective viewpoints through lenses. FIG. 35 is a diagram illustrating an example structure of a barrier unit 6A that divides image light and guides the divided light to respective viewpoints through lenses. As illustrated in FIG. 35, the parallax forming unit includes lenticular lenses arranged so that the surfaces of the lenticular lenses on the viewpoint side are arc-like surfaces. The lenticular lenses are provided to guide the light of images for the respective viewpoints to the respective viewpoints in accordance with the predetermined viewpoints and the distance between the display unit 4 and the respective viewpoints. With the lenses, a larger number of lights can be guided to the respective viewpoints. Accordingly, the luminance of each three-dimensional image can be increased.

In the case of the above embodiment and any of the first through fourth modifications, each minimum divisional unit region includes light from pixels of colors included in one unit pixel containing pixels of all three or more colors. However, this is an example of pixels included in a minimum divisional unit region, and the present disclosure is not limited to this example. The pixels may be monochrome pixels.

Each of the image display patterns illustrated in FIG. 19 and FIGS. 22 through 25 is merely an example. The number of successive pixels in the predetermined direction (the X-direction, for example) that function as the pixels of a left-eye image P1 or the pixels of a right-eye image P2 is determined in accordance with the number of pixels from which light is guided by one opening.

The present invention can also be applied in a case where both the width of each pixel in the predetermined direction (the X-direction, for example) and the width of each pixel in the direction (the Y-direction, for example) that is parallel to the screen and is perpendicular to the predetermined direction are equal to or smaller than the predetermined width. In this case, as described above in the fourth modification, image light can be divided into minimum divisional unit regions, each of which is formed with pixels arranged in the predetermined direction and the direction that is parallel to the screen of the display unit 4 and is perpendicular to the predetermined direction, for example. In this manner, image overlap phenomena can be prevented.

Although the unit regions 150 are successive in the Y-direction in the above described embodiment, this arrangement is merely an example, and the present invention is not limited to this example. The unit regions 150 may be divided into minimum divisional unit regions with respect to the Y-direction, for example. In this case, the unit regions divided with respect to the Y-direction are controlled independently of one another. The unit regions may or may not be successively arranged in the Y-direction also in a case where the parallax forming unit is a plate-like structure or includes lenses.

The viewpoints are not necessarily the right eye and the left eye of a user. The present invention can also be applied in a case where light of corresponding images is guided to the right eyes and the left eyes of users.

Although the control unit 9 and the barrier control unit 7 are provided independently of each other in the above described embodiment, the control unit 9 and the barrier control unit 7 maybe integrated as one control unit. A processing unit that performs some or all of the processes performed by the control unit 9 in the above embodiment may be provided.

Although a liquid crystal display device has been described as a disclosed example in the above embodiment, other example applications include EL (Electro-Luminescence) display devices, display devices of the other light-emitting types, electronic-paper display devices including electrophoretic elements and the like, and flat-panel display devices of all kinds. The present invention can of course be applied to display devices of small to large sizes without any particular restriction.

Various modifications and changes within the spirit of the present invention should be obvious to those skilled in the art, and it should be understood that those modifications and changes fall within the scope of the present invention. For example, embodiments formed by those skilled in the art adding a component to or deleting a component from any of the embodiments described above, making a change to the design of any of the embodiments described above, adding a procedure to or deleting a procedure from any of the embodiments described above, or changing conditions in the embodiments described above fall within the scope of the present invention, as long as those embodiments involve the subject matter of the present invention.

Other functions and effects to be apparently achieved from the modes described in the embodiments disclosed in this specification, and embodiments that can be easily formed by those skilled in the art should also be construed as included in the present invention.

What is claimed is:

1. A display device comprising:
a display unit configured to display, in a screen, images corresponding to a plurality of viewpoints existing in a predetermined direction; and
a parallax forming unit configured to divide light existing between the display unit and the respective viewpoints with respect to the predetermined direction so that different lights reach the respective viewpoints from the display unit due to light blocking or refraction, and guide the images corresponding to the respective viewpoints to the respective viewpoints, wherein
the display unit includes a plurality of pixels displaying the images, and,
when at least one of a width of each of the pixels in the predetermined direction, and a width of each of the pixels in a direction parallel to the screen as well as perpendicular to the predetermined direction is equal to or smaller than a predetermined width, the parallax forming unit divides light beams existing between the display unit and the respective viewpoints so that light of a plurality of pixels is included in a minimum divisional unit region formed through the dividing.

2. The display device according to claim 1, wherein a width of the minimum divisional unit region in the predetermined direction depends on a distance between the parallax forming unit and the viewpoints.

3. The display device according to claim 2, wherein
the parallax forming unit includes a switching unit configured to switch between light blocking and light transmission for each unit width smaller than the predetermined width, and
the display device further comprises a switch control unit configured to control the switching unit to switch between light transmission and non-transmission for each unit in accordance with the distance between the parallax forming unit and the viewpoints.

4. The display device according to claim 3, further comprising
a calculating unit configured to calculate the distance between the parallax forming unit and the viewpoints by detecting positions of the viewpoints with respect to the parallax forming unit from positional information about the left eye and the right eye of a user.

5. The display device according to claim 1, wherein a width of the minimum divisional unit region in the predetermined direction is 15 μm or greater.

6. The display device according to claim 1, wherein the pixels are arranged so that a width of each of the pixels in the predetermined direction is greater than a width of each of the pixels in the direction perpendicular to the predetermined direction.

7. A display method implemented by a display device including: a display unit configured to display, in a screen, images corresponding to a plurality of viewpoints existing in a predetermined direction; and a parallax forming unit configured to divide light existing between the display unit and the respective viewpoints with respect to the predetermined direction so that different lights reach the respective viewpoints from the display unit due to light blocking or refraction, and guide the images corresponding to the respective viewpoints to the respective viewpoints, the display method comprising
dividing light beams existing between the display unit and the respective viewpoints so that light of a plurality of pixels is included in a minimum divisional unit region formed through the dividing, when at least one of a width of each of a plurality of pixels displaying the images in the predetermined direction, and a width of each of the pixels in a direction parallel to the screen as well as perpendicular to the predetermined direction is equal to or smaller than a predetermined width.
